(19) United States
(12) Patent Application Publication
(10) Pub. No.: US 2026/0052443 A1
(43) Pub. Date: Feb. 19, 2026

(54) CONFIGURED GRANT BASED CELL SWITCH

(71) Applicant: Samsung Electronics Co., Ltd., Suwon-si (KR)

(72) Inventor: Anil Agiwal, McKinney, TX (US)

(21) Appl. No.: 19/296,834

(22) Filed: Aug. 11, 2025

Related U.S. Application Data
(60) Provisional application No. 63/684,732, filed on Aug. 19, 2024.
(60) Provisional application No. 63/696,031, filed on Sep. 18, 2024.

(51) Int. Cl. H04W 36/08; H04W 36/00

(52) U.S. Cl. CPC H04W 36/08; H04W 36/0072

(57) ABSTRACT

A user equipment (UE) capable of facilitating communications in a wireless system can include a transceiver and a processor. In some examples, the transceiver is to receive, from a base station (BS), an LTM cell switch command MAC CE for performing a LTM cell switch. If a presence of a UL TCI state ID field is determined, selecting a SSB associated with a TCI state indicated by a UL TCI state ID field and selecting a configured grant associated with the selected SSB for an initial uplink transmission towards a candidate cell. If the absence of the UL TCI state ID field is determined, selecting a SSB associated with a TCI state indicated by a TCI state ID field of the LTM cell switch command MAC CE and selecting a configured grant associated with the selected SSB for the initial uplink transmission towards the candidate cell.

### CROSS-REFERENCE TO RELATED APPLICATIONS

This application claims the benefit of priority from U.S. Provisional Application No. 63/684,732, entitled “CONFIGURED GRANT BASED CELL SWITCH,” filed Aug. 19, 2024; and U.S. Provisional Application No. 63/696,031, entitled “ACQUIRING SYSTEM INFORMATION,” filed Sep. 18, 2024, all which are incorporated herein by reference in their entirety.

### TECHNICAL FIELD

This disclosure relates generally to a wireless communication system, and more particularly to, for example, but not limited to, user equipment (UE) signaling for UE grant based cell switch.

### BACKGROUND

Mobility management operations including network handovers can be pivotal aspects of a wireless communication system. These systems include, for example, LTE and 5G New Radio (NR), and upcoming technologies currently coined “6G”. When a mobile terminal (e.g., a user equipment (UE)) moves from one coverage area of a cell to another coverage area of another cell, handover may be performed to hand over the UE to a target cell with superior signal quality. To reduce interruptions in servicing the UE, the handover should be performed as quick as possible with the shortest possible interruption to data transmission and data reception.

The inclusion of enhanced broadband mechanisms requiring high speeds and low latencies has necessitated more sophisticated handover mechanisms. Accordingly, layer 1/layer 2 triggered mobility (LTM) has been introduced to provide additional conditions for specific networks or slices thereof to increase handover speed and reduce mobile latency. The LTM procedure involves a network (e.g., base station or gNB) receiving L1 measurements from a UE and based on the measurements, the gNB can change the UE's serving cell by a cell switch command signaled in a medium access control (MAC) control element (CE). The UE can switch to the target cell according to the cell switch command. The LTM procedure can be performed in multiple ways. For example, a network can indicate in a cell switch command whether the UE shall access the target cell with a random access (RA) procedure if a timing advance (TA) value is not provided or with a physical uplink shared channel (PUSCH) transmission using the indicated TA value. In some examples, for non-random access channel (e.g., RACH-less) LTM, the UE accesses the target cell via a configured grant provided in radio resource control (RRC) signaling and selects the configured grant occasion associated with the beam indicated in the cell switch command.

However, if a MAC entity receives an LTM cell switch command MAC CE on a serving cell, a synchronization signal block (SSB) associated to a transmission configuration indicator (TCI) state indicated by a TCI state identification (ID) field is the one used for configured uplink grant selection for an initial uplink transmission towards the candidate cell for RACH-less LTM cell switch. However, the LTM cell switch command MAC CE has two TCI state fields, a TCI state ID and an uplink (UL) TCI state ID. However, current operations and LTM procedures do not consider separate TCI states for downlink and UL transmissions or presence of two TCI state fields in the LTM cell switch command MAC CE. Additionally, there is not a sufficient way to select a configured uplink grant if the LTM cell switch command MAC CE is associated with a channel state information reference signal (CSI-RS). Accordingly, additional procedures are desired in order to provide better LTM handovers and further reduce latency of the wireless communication system.

The description set forth in the background section should not be assumed to be prior art merely because it is set forth in the background section. The background section may describe aspects or embodiments of the present disclosure.

### SUMMARY

An aspect of the present disclosure provides for a user equipment (UE) for facilitating communication in a wireless network, the UE including a transceiver to cause receiving, from a base station (BS), a layer one/layer two triggered mobility (LTM) cell switch command medium access control (MAC) control element (CE) for performing LTM cell switch from a serving cell to a candidate cell, determining a presence or absence of an uplink (UL) transmission configuration indicator (TCI) state identification (ID) field in the LTM cell switch command MAC CE, wherein if the presence of the UL TCI state ID field is determined, selecting a synchronization signal block (SSB) associated with a TCI state indicated by the UL TCI state ID field and selecting a configured grant associated with the selected SSB associated with the TCI state indicated by the UL TCI state ID field for an initial uplink transmission towards the candidate cell and if the absence of the UL TCI state ID field is determined, selecting a SSB associated with a TCI state indicated by a TCI state ID field of the LTM cell switch command MAC CE and selecting a configured grant associated with the selected SSB associated with the TCI state indicated by the TCI state ID field for the initial uplink transmission towards the candidate cell.

In an embodiment, the transceiver is further to cause receiving, before the LTM cell switch command MAC CE, a reconfiguration message including LTM configuration information for a plurality of candidate cells, wherein the plurality of candidate cells comprises the candidate cell.

In an embodiment, the processor is further to cause determining the SSB associated with the TCI state indicated by the UL TCI state ID field is based at least in part on an uplink TCI state list mapping one or more UL TCI states to one or more SSBs wherein the uplink TCI state list is received in the LTM configuration information and determining the SSB associated with the TCI state indicated by the TCI state ID field is based at least in part on a joint or downlink TCI state list mapping one or more joint or downlink TCI states to one or more SSBs wherein the joint or downlink TCI state list is received in the LTM configuration information.

In an embodiment, the configured grant associated with the selected SSB is selected from a plurality of configured grants configured by configured grant configuration for random access channel (RACH)-less LTM cell switch in the LTM configuration of candidate cells.

In an embodiment, the processor is further to cause performing one or more measurements on the plurality of candidate cells and transmitting the one or more measurements on the plurality of candidate cells to the BS, wherein receiving the LTM cell switch command MAC CE is based at least in part on transmitting the one or more measurements.

In an embodiment, the TCI state is associated with a channel state information-reference signal (CSI-RS), and the processor is further to cause if the UL TCI state ID field is included in the LTM cell switch command CE, selecting a first CSI-RS associated to the TCI state indicated by the UL TCI state ID for the configured grant UL selection for the initial transmission towards the candidate cell and if the UL TCI state ID field is absent in the LTM cell switch command MAC CE, selecting a second CSI-RS associated to the TCI state indicated by the TCI state ID field in the LTM cell switch command MAC CE for the configured grant UL selection for the initial transmission towards the candidate cell.

In an embodiment, the TCI state is associated with a tracking reference signal (TRS), and the processor is further to cause if the UL TCI state ID field is included in the LTM cell switch command MAC CE, selecting a first TRS associated to the TCI state indicated by the UL TCI state ID for the configured grant UL selection for the initial transmission towards the candidate cell and if the UL TCI state ID field is absent in the LTM cell switch command MAC CE, selecting a second TRS associated to the TCI state indicated by the TCI state ID filed in the LTM cell switch command MAC CE for the configured grant UL selection for the initial transmission towards the candidate cell.

An aspect of the present disclosure provides for a method performed by a user equipment (UE) for facilitating communication in a wireless network including receiving, from a base station (BS), a layer one/layer two triggered mobility (LTM) cell switch command medium access control (MAC) control element (CE) for performing LTM cell switch from a serving cell to a candidate cell, determining a presence or absence of an uplink (UL) transmission configuration indicator (TCI) state identification (ID) field in the LTM cell switch command MAC CE, wherein if the presence of the UL TCI state ID field is determined, selecting a synchronization signal block (SSB) associated with a TCI state indicated by the UL TCI state ID field and selecting a configured grant associated with the selected SSB associated with the TCI state indicated by the UL TCI state ID field for an initial uplink transmission towards the candidate cell and if the absence of the UL TCI state ID field is determined, selecting a SSB associated with a TCI state indicated by a TCI state ID field of the LTM cell switch command MAC CE and selecting a configured grant associated with the selected SSB associated with the TCI state indicated by the TCI state ID field for the initial uplink transmission towards the candidate cell.

In an embodiment, the method further includes receiving, before the LTM cell switch command MAC CE, a reconfiguration message including LTM configuration information for a plurality of candidate cells, wherein the plurality of candidate cells comprises the candidate cell.

In an embodiment, the method further includes determining the SSB associated with the TCI state indicated by the UL TCI state ID field is based at least in part on an uplink TCI state list mapping one or more UL TCI states to one or more SSBs wherein the uplink TCI state list is received in the LTM configuration information and determining the SSB associated with the TCI state indicated by the TCI state ID field is based at least in part on a joint or downlink TCI state list mapping one or more joint or downlink TCI states to one or more SSBs wherein the joint or downlink TCI state list is received in the LTM configuration information.

In an embodiment, the method further includes performing one or more measurements on the plurality of candidate cells and transmitting the one or more measurements on the plurality of candidate cells to the BS, wherein receiving the LTM cell switch command MAC CE is based at least in part on transmitting the one or more measurements.

In an embodiment, the configured grant associated with the selected SSB is selected from a plurality of configured grants configured by configured grant configuration for random access channel (RACH)-less LTM cell switch in the LTM configuration of candidate cells.

In an embodiment, the TCI state is associated with a channel state information-reference signal (CSI-RS), and the method further includes if the UL TCI state ID field is included in the LTM cell switch command CE, selecting a first CSI-RS associated to the TCI state indicated by the UL TCI state ID for the configured grant UL selection for the initial transmission towards the candidate cell and if the UL TCI state ID field is absent in the LTM cell switch command MAC CE, selecting a second CSI-RS associated to the TCI state indicated by the TCI state ID field in the LTM cell switch command MAC CE for the configured grant UL selection for the initial transmission towards the candidate cell.

In an embodiment, the TCI state is associated with a tracking reference signal (TRS), and wherein the method further includes if the UL TCI state ID field is included in the LTM cell switch command MAC CE, selecting a first TRS associated to the TCI state indicated by the UL TCI state ID for the configured grant UL selection for the initial transmission towards the candidate cell and if the UL TCI state ID field is absent in the LTM cell switch command MAC CE, selecting a second TRS associated to the TCI state indicated by the TCI state ID filed in the LTM cell switch command MAC CE for the configured grant UL selection for the initial transmission towards the candidate cell.

An aspect of the present disclosure provides for a wireless network including two or more base stations (BS) for facilitating communication in a wireless network, the two or more BS comprising a first BS and a second BS, wherein the first BS is to cause transmitting, to a user equipment (UE), a layer one/layer two triggered mobility (LTM) cell switch command medium access control (MAC) control element (CE) for performing LTM cell switch from a serving cell associated with the first BS to a candidate cell associated with the second BS wherein the second BS is to cause if an uplink (UL) transmission configuration indicator (TCI) state identification (ID) field is included in the LTM cell switch command, receiving, from the UE, an initial uplink transmission associated with a first configured UL grant corresponding to a first signal synchronization block (SSB) associated with a TCI state indicated by the UL TCI state ID field and if an uplink (UL) transmission configuration indicator (TCI) state identification (ID) field is absent in the LTM cell switch command, receiving, from the UE, an initial uplink transmission associated with a second configured UL grant corresponding to a second SSB associated with a TCI state indicated by a TCI state ID field of the LTM cell switch command MAC CE.

In an embodiment, the first BS is further to cause transmitting, before the LTM cell switch command MAC CE, a reconfiguration message including LTM configuration information for a plurality of candidate cells, wherein the plurality of candidate cells comprises the candidate cell associated with the second BS.

In an embodiment, the first BS is further to cause transmitting, to the UE in the LTM configuration information, an uplink TCI state list mapping one or more UL TCI states to one or more SSBs and transmitting, to the UE in the LTM configuration information, a joint or downlink TCI state list mapping one or more joint or downlink TCI states to one or more SSBs.

In an embodiment, the first BS if further to cause receiving, from the UE, one or more measurements on the plurality of candidate cells and selecting, from the plurality of candidate cells, the candidate cell based at least in part on receiving the one or more measurements.

In an embodiment, the first configured grant or second configured grant is configured by configured grant configuration for random access channel (RACH)-less LTM cell switch in the LTM configuration of the candidate cell.

In an embodiment, the second BS is further to cause terminating the LTM cell switch procedure based at least in part on receiving the initial uplink transmission from the UE.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process 400 for an L1/L2 Triggered Mobility procedure in accordance with an embodiment.

FIG. 5 shows an example process 500 for an L1/L2 Triggered Mobility procedure in accordance with an embodiment.

FIG. 6 shows an example process 600 for updating MIBs and SIBs in accordance with an embodiment.

FIG. 7 shows an example process 700 for verifying MIBs in accordance with an embodiment.

FIG. 8 shows an example process 800 for verifying MAC I in accordance with an embodiment.

FIGS. 9-11 show an example process 900, 1000, and 1100, respectively, for acquiring a SIB in accordance with an embodiment.

FIG. 12 shows an example process 1200 for an LTM procedure in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHZ, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

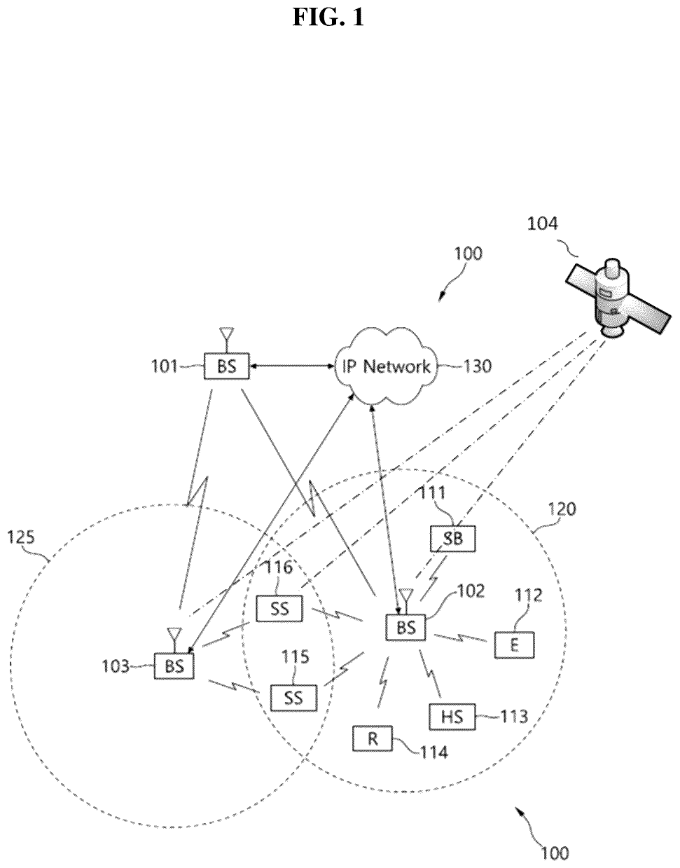

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

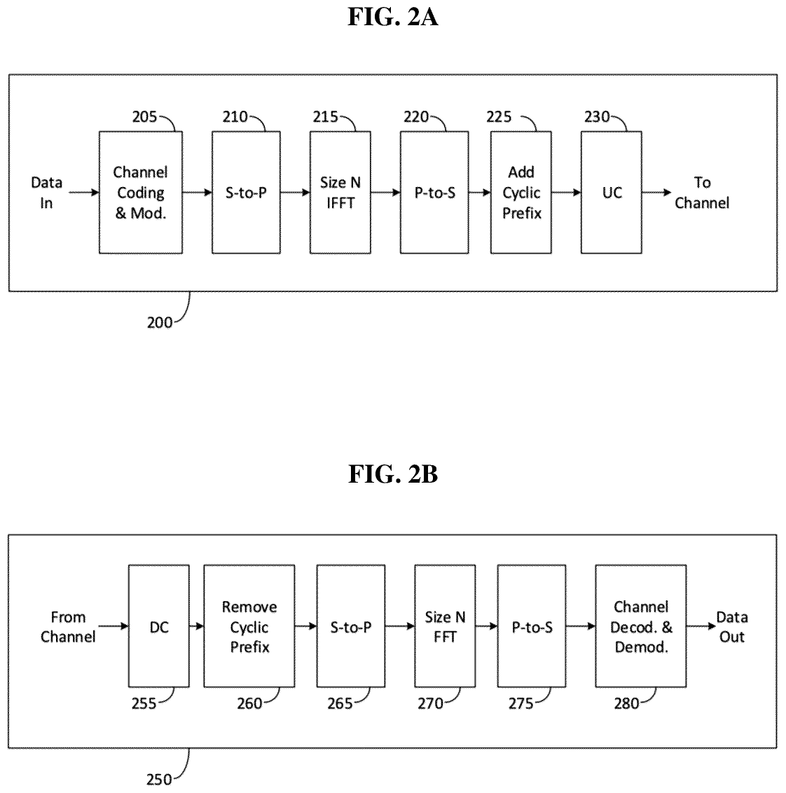

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

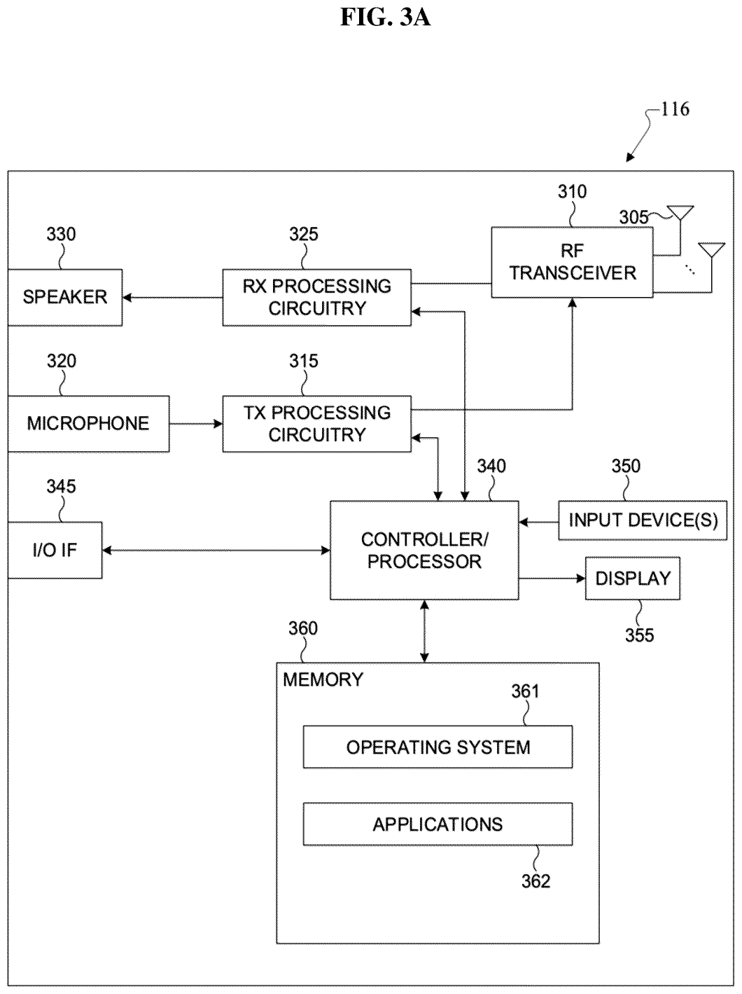

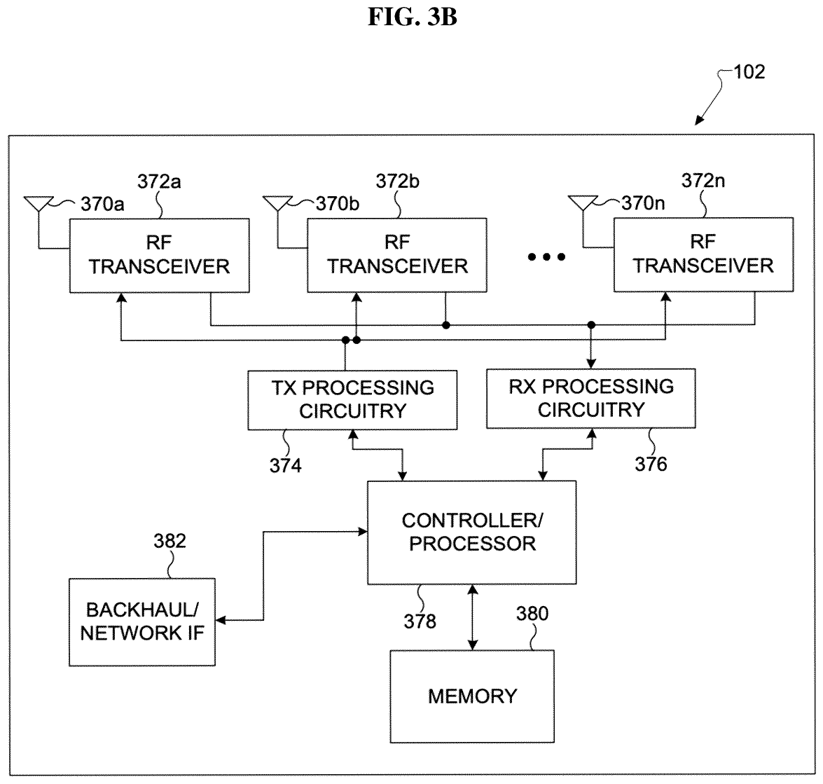

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof.” The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure.

The following documents are hereby incorporated by reference in their entirety into the present disclosure as if fully set forth herein: i) 3GPP TS 38.321 v18.1.0.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

In at least one embodiment, the fifth generation wireless communication system, supports standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilize radio resources provided by two distinct schedulers, located in two different nodes connected via a non-ideal backhaul and providing either E-UTRA (Evolved universal mobile telecommunication systems (UMTS) terrestrial radio access (e.g., if the node is an ng-eNB) or NR access (e.g., if the node is a gNB). In NR for a UE in RRC_CONNECTED not configured with carrier aggregation (CA)/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell (secondary cell) is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (e.g., Special Cell) refers to the PCell of the MCG or the PSCell of the SCG, otherwise the term Special Cell refers to the PCell.

In one embodiment, for the fifth generation wireless communication system, node B (gNB) or base station in cell broadcast Synchronization Signal and PBCH block (SSB) consists of primary and secondary synchronization signals (PSS, SSS) and system information. System information includes common parameters needed to communicate in cell. In the fifth generation wireless communication system (also referred as next generation radio or NR), System Information (SI) is divided into the master information block (MIB) and a number of system information blocks (SIBs) where, the MIB is always transmitted on the broadcast channel (BCH) with a periodicity of 80 ms and repetitions made within 80 ms and it includes parameters that are needed to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and control resource set (CORESET) multiplexing pattern 1, SIB1 repetition transmission period is 20 ms. For SSB and CORESET multiplexing pattern 2/3, SIB1 transmission repetition period is the same as the SSB period. SIB1 includes information regarding the availability and scheduling (e.g. mapping of SIBs to system information (SI) message, periodicity, SI-window size) of other SIBs with an indication whether one or more SIBs are only provided on-demand and, in that case, the configuration needed by the UE to perform the SI request. SIB1 is cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message; For a UE in RRC_CONNECTED, the network can provide system information through dedicated signaling using the RR (Reconfiguration message, e.g. if the UE has an active bandwidth part (BWP) with no common search space configured to monitor system information, paging, or upon request from the UE. In RRC_CONNECTED, UE needs to acquire the required SIB(s) only from PCell. For PSCell and SCells, the network provides the required SI by dedicated signaling, e.g., within an RR (Reconfiguration message. Nevertheless, the UE shall acquire MIB of the PSCell to get SFN timing of the SCG (which may be different from MCG). Upon changing relevant SI for SCell, the network releases and adds the concerned SCell. For PSCell, the required SI can only be changed with Reconfiguration with synchronization.

In one embodiment, in the fifth generation wireless communication system, Physical Downlink Control Channel (PDCCH) is used to schedule DL transmissions on PDSCH and UL transmissions on physical uplink shared channel (PUSCH), where the Downlink Control Information (DCI) on PDCCH includes downlink assignments containing at least modulation and coding format, resource allocation, and hybrid-ARQ information related to DL-SCH, uplink scheduling grants containing at least modulation and coding format, resource allocation, and hybrid-ARQ information related to UL-SCH. In addition to scheduling, PDCCH can be used to for activation and deactivation of configured PUSCH transmission with configured grant, activation and deactivation of PDSCH semi-persistent transmission, notifying one or more UEs of the slot format, notifying one or more UEs of the physical resource blocks (PRB(s)) and OFDM symbol(s) where the UE may assume no transmission is intended for the UE, transmission of transmit power control (TPC) commands for PUCCH and PUSCH, transmission of one or more TPC commands for SRS transmissions by one or more UEs, switching a UE's active bandwidth part, and/or initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). QPSK modulation is used for PDCCH.

In fifth generation wireless communication system, a list of search space configurations is signalled by GNB for each configured BWP of serving cell wherein each search configuration is uniquely identified by a search space identifier. Search space identifier is unique amongst the BWPs of a serving cell. Identifier of search space configuration to be used for specific purpose such as paging reception, SI reception, random access response reception is explicitly signalled by gNB for each configured BWP. In NR search space configuration comprises of parameters monitoring-periodicity-PDCCH-slot, monitoring-offset-PDCCH-slot, and/or monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation: y*(number of slots in a radio frame)+x−Monitoring-offset-PDCCH-slot) mod (Monitoring-periodicity-PDCCH-slot)=0).

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations are signaled by GNB for each configured BWP of serving cell wherein each coreset configuration is uniquely identified by an coreset identifier. Coreset identifier is unique amongst the BWPs of a serving cell. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of TCI (Transmission configuration indicator) states. One DL RS ID (SSB or CSI RS) is configured per TCI state. The list of TCI states corresponding to a coreset configuration is signaled by gNB via RRC signaling. One of the TCI state in TCI state list is activated and indicated to UE by gNB. TCI state indicates the DL TX beam (DL TX beam is QCLed with SSB/CSI RS of TCI state) used by GNB for transmission of PDCCH in the PDCCH monitoring occasions of a search space.

In one embodiment, fifth generation wireless communication system bandwidth adaptation (BA) is supported. With BA, the receive and transmit bandwidth of a UE need not be as large as the bandwidth of the cell and can be adjusted. That is, the width can be ordered to change (e.g. to shrink during period of low activity to save power), the location can move in the frequency domain (e.g. to increase scheduling flexibility), and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP e.g., it does not have to monitor PDCCH on the entire DL frequency of the serving cell. In RRC connected state, UE is configured with one or more DL and UL BWPs, for each configured Serving Cell (e.g., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-Inactivity Timer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In one embodiment, in the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC_CONNECTED state. Several types of random access procedure is supported.

In one embodiment, the 5G wireless communication system can support Contention based random access (CBRA). In one embodiment, this is also referred as 4 step CBRA. In this type of random access, UE first transmits Random Access preamble (also referred as Msg1) and then waits for Random access response (RAR) in the RAR window. RAR is also referred as Msg2. Next generation node B (gNB) transmits the RAR on physical downlink shared channel (PDSCH). PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where UE has transmitted Msg1, e.g., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various Random-access preambles detected by gNB can be multiplexed in the same RAR media access control (MAC) protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by gNB in RACH configuration) number of times, the UE goes back to first step e.g., select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. It may include the UE identity (e.g., cell-radio network temporary identifier (C-RNTI) or system architecture evolution (SAE)-temporary mobile subscriber identity (S-TMSI) or a random number). After transmitting the Msg3, UE starts a contention resolution timer. While the contention resolution timer is running, if UE receives a physical downlink control channel (PDCCH) addressed to C-RNTI included in Msg3, contention resolution is considered successful, contention resolution timer is stopped and RA procedure is completed. While the contention resolution timer is running, if UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and UE has not yet transmitted the RA preamble for a configurable number of times, UE goes back to first step e.g., select random access resource (preamble/RACH occasion) and transmits the RA preamble. A backoff may be applied before going back to first step.

In an embodiment, the 5G wireless communication system can support contention free random access (CFRA). In an embodiment, this is also referred as legacy CFRA or 4 step CFRA. CFRA procedure is used for scenarios such as handover where low latency is required, timing advance establishment for secondary cell (Scell), etc. Evolved node B (eNB) assigns to UE dedicated Random access preamble. UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to contention-based RA (CBRA) procedure. CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

For certain events such has handover and beam failure recovery if dedicated preamble(s) are assigned to UE, during first step of random access—e.g., during random access resource selection for Msg1 transmission UE determines whether to transmit dedicated preamble or non dedicated preamble. Dedicated preambles is typically provided for a subset of SSBs/CSI RSs. If there is no SSB/CSI RS having DL RSRP above a threshold amongst the SSBs/CSI RSs for which contention free random access resources (e.g., dedicated preambles/ROs) are provided by gNB, UE select non dedicated preamble. Otherwise, UE select dedicated preamble. So, during the RA procedure, one random access attempt can be CFRA while other random access attempt can be CBR.

In one embodiment, for 2 step contention based random access (2 step CBRA), in the first step, UE transmits random access preamble on PRACH and a payload (i.e. MAC PDU) on PUSCH. The random access preamble and payload transmission is also referred as MsgA. In the second step, after MsgA transmission, the UE monitors for a response from the network (i.e. gNB) within a configured window. The response is also referred as MsgB. Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If CCCH SDU was transmitted in MsgA payload, UE performs contention resolution using the contention resolution information in MsgB. The contention resolution is successful if the contention resolution identity received in MsgB matches the first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, UE transmits Msg3 and performs contention resolution using Msg4 as in CBRA procedure. If contention resolution is successful, random access procedure is considered successfully completed. If contention resolution fails upon fallback (e.g., upon transmitting Msg3), UE retransmits MsgA. If the configured window in which UE monitor network response after transmitting MsgA expires and UE has not received MsgB including contention resolution information or fallback information as explained above, UE retransmits MsgA. If the random access procedure is not successfully completed even after transmitting the msgA configurable number of times, UE fallbacks to 4 step RACH procedure—e.g., UE only transmits the PRACH preamble.

In an embodiment, the MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. MsgA may include UE ID (e.g. random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which UE performs the RA procedure. When UE performs RA after power on (before it is attached to the network), then UE ID is the random ID. When UE perform RA in IDLE state after it is attached to network, the UE ID is S-TMSI. If UE has an assigned C-RNTI (e.g. in connected state), the UE ID is C-RNTI. In case UE is in INACTIVE state, UE ID is resume ID. In addition to UE ID, some addition ctrl information can be sent in MsgA. The control information may be included in the MAC PDU of the MsgA. The control information may include one or more of connection request indication, connection resume request indication, SI request indication, buffer status indication, beam information (e.g. one or more DL TX beam ID(s) or SSB ID(s)), beam failure recovery indication/information, data indicator, cell/BS/TRP switching indication, connection re-establishment indication, reconfiguration complete or handover complete message, etc.

In an embodiment, for 2 step contention free random access (2 step CFRA), the gNB can assign to the UE, dedicated Random access preamble(s) and PUSCH resource(s) for MsgA transmission. Random access occasions (RO(s)) to be used for preamble transmission may also be indicated. In the first step, UE transmits random access preamble on PRACH and a payload on PUSCH using the contention free random access resources (e.g., dedicated preamble/PUSCH resource/RO). In the second step, after MsgA transmission, the UE monitors for a response from the network (e.g., gNB) within a configured window. The response is also referred as MsgB.

In at least one embodiment, the next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1—e.g., RA preamble; OS s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If UE receives PDCCH addressed to C-RNTI, random access procedure is considered successfully completed. If UE receives fallback information corresponding to its transmitted preamble, random access procedure is considered successfully completed.

For certain events such has handover and beam failure recovery if dedicated preamble(s) and PUSCH resource(s) are assigned to UE, during first step of random access—e.g., during random access resource selection for MsgA transmission UE determines whether to transmit dedicated preamble or non dedicated preamble. Dedicated preambles is typically provided for a subset of SSBs/CSI RSs. If there is no SSB/CSI RS having DL RSRP above a threshold amongst the SSBs/CSI RSs for which contention free random access resources (e.g., dedicated preambles/ROs/PUSCH resources) are provided by gNB, UE select non dedicated preamble. Otherwise UE select dedicated preamble. So during the RA procedure, one random access attempt can be 2 step CFRA while other random access attempt can be 2 step CBRA.

Upon initiation of random access procedure, UE first selects the carrier (secondary uplink (SUL) or NUL). If the carrier to use for the Random Access procedure is explicitly signaled by gNB, UE select the signaled carrier for performing Random Access procedure. If the carrier to use for the Random Access procedure is not explicitly signaled by gNB; and if the Serving Cell for the Random Access procedure is configured with supplementary uplink and if the RSRP of the downlink pathloss reference is less than rsrp-ThresholdSSB-SUL: UE select the SUL carrier for performing Random Access procedure. Otherwise, UE select the NUL carrier for performing Random Access procedure. Upon selecting the UL carrier, UE determines the UL and DL BWP for random access procedure as specified in section 5.15 of TS 38.321.

UE then determines whether to perform 2 step or 4 step RACH for this random access procedure. If this random access procedure is initiated by PDCCH order and if the ra-PreambleIndex explicitly provided by PDCCH is not 0b000000, UE selects 4 step RACH. In other embodiments, else if 2 step contention free random access resources are signaled by gNB for this random access procedure, UE selects 2 step RACH. In one embodiment, else if 4 step contention free random access resources are signaled by gNB for this random access procedure, UE selects 4 step RACH. In other embodiments, else if the UL BWP selected for this random access procedure is configured with only 2 step RACH resources, UE selects 2 step RACH. In at least one embodiment, else if the UL BWP selected for this random access procedure is configured with only 4 step RACH resources, UE selects 4 step RACH. In one embodiment, else if the UL BWP selected for this random access procedure is configured with both 2 step and 4 step RACH resources. In one embodiment, if RSRP of the downlink pathloss reference is below a configured threshold, UE selects 4 step RACH. Otherwise, UE selects 2 step RACH.

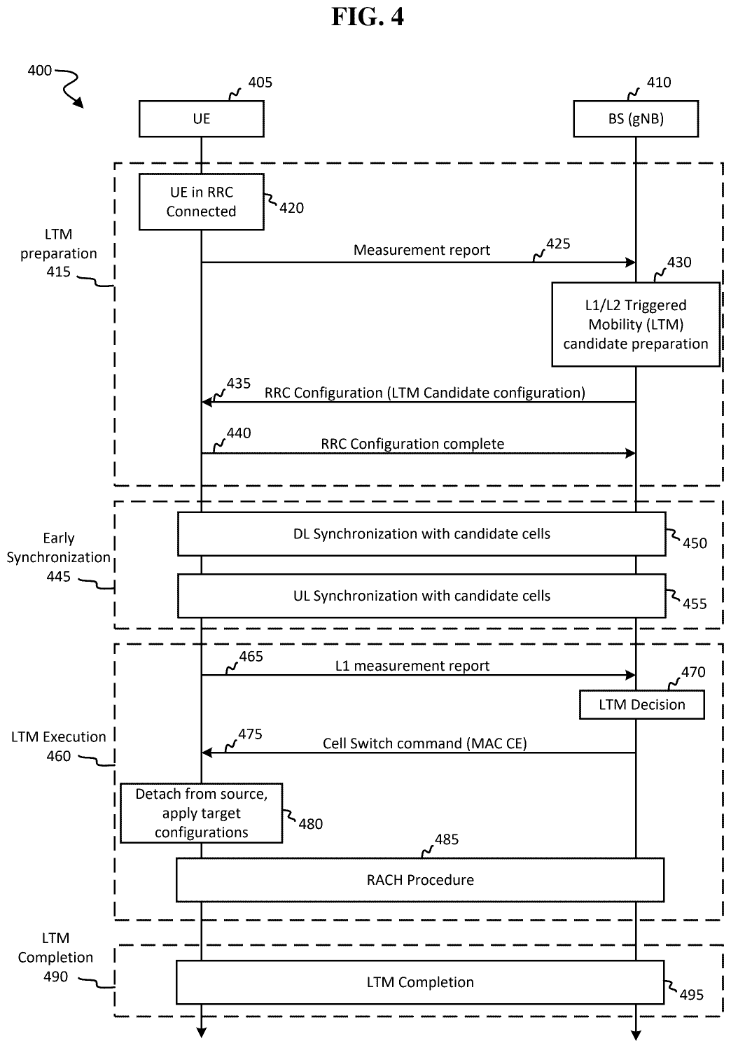

FIG. 4 shows an example process 400 for a layer 1/layer 2 (L1/L2) triggered mobility (LTM) operation. For explanatory and illustration purposes, the example process 400 may be performed by user equipment (UE) 405 (e.g., UE 111-116 as described with reference to FIG. 1) and base station (BS) 410 (e.g., BS 101-103 as described with reference to FIG. 1). In some embodiments, the BS 410 is an example of a next generation node B, gNodeB (gNB). In some embodiments, a processor or transceiver of the UE 405 or BS 410 can perform the operations described herein. Although one or more operations are described or shown in particular sequential order, in other embodiments the operations may be rearranged in a different order, which may include performance of multiple operations in at least partially overlapping time periods. In an embodiment, FIG. 4 illustrates a conventional LTM procedure.

In an embodiment, LTM is a procedure in which a BS 410 (e.g., gNB) receives a L1 measurement report(s) from a UE 405. In such embodiments, the BS 410 changes the UE's serving cell by a cell switch command signaled via a medium access control (MAC) control element (CE) based on the received measurement reports of the UE 405. In one embodiment, the cell switch command can indicate an LTM candidate cell configuration that the BS 410 previously prepared and provided to the UE 405 through radio resource control (RCC) signaling. In such embodiment, the LTM candidate cell can refer to a potential cell the UE 405 can switch to e.g., the BS 410 can provide a plurality of candidate cells that the UE 405 could potentially handover to. In at least one embodiment, after receiving the cell switch command, the UE 405 can switch to a target cell (e.g., a selected candidate cell for the handover) according to the cell switch command. In at least one embodiment, the LTM operation can be utilized to reduce a mobility latency. In one embodiment, a network can request the UE 405 to perform early timing advance (TA) acquisition of a candidate cell before a cell switch. In such embodiments, the early TA acquisition is triggered by a physical downlink control channel (PDDCH) order or through a UE-based TA measurement.

In an embodiment, the BS 410 indicates in the cell switch command the UE 405 will access the target cell with a random access (RA) procedure if a TA value is not provided or with a physical uplink shared channel (PUSCH) transmission using the indicated TA value in the PUSCH transmission. In other embodiments, for non-random access channel (e.g., RACH-less) LTM, the UE 405 accesses the target cell via a configured granted provided in the RRC signaling and selects the configured grant occasion associated with the beam indicated in the cell switch command. In some embodiments, if the UE 405 does not receive the configured grant in the RRC signaling, the UE 405 monitors the PDCCH for dynamic scheduling from the target cell upon LTM cell switch.

More specifically, referring to FIG. 4, during an LTM preparation phase 415, at operation 420 the UE 405 can be in an RRC connected mode (e.g., RRC_connected where UE 405 has an RRC connection with the network).

At operation 425, the UE 405 transmits a measurement report (e.g., MeasurementReport) message to the BS 410 (e.g., gNB).

At operation 430, the gNB configures LTM and initiates a candidate cell(s) preparation responsive to receiving the measurement report from the UE 405. For example, the BS 410 can determine a measured quality or signal strength of a received signal of a source cell is below a certain threshold and that a measured quality or signal strength of a received signal from a neighboring cell is above a certain threshold.

At operation 435, the BS 410 transmits an RRC configuration message (e.g., RRCReconfiguration) to the UE 405. In at least one embodiment, the RRC configuration message can include the LTM candidate cell configurations of one or multiple candidate cells for the UE 405 to possibly switch to. In an embodiment, the UE 405 stores the LTM candidate cell configurations.

At operation 440, the UE 405 transmits an RRC configuration complete (e.g., RRCReconfigurationComplete) message to the BS 410. In an embodiment, the UE 405 can transmit the RRC configuration complete message based on storing the LTM candidate cell configurations. In one embodiment, the operation 440 can signal an end of the LTM preparation phase 415. In such embodiments, the UE 405 and BS 410 can proceed to an early synchronization phase 445.

During the early synchronization phase 445, at operation 450, the UE can perform downlink synchronization with candidate cell(s) before receiving a cell switch command.

At operation 455, the UE 405 can perform uplink (UL) synchronization with candidate cells if requested by the network or BS 410. In such embodiments, the UE 405 can perform early TA acquisition with candidate cell(s) before receiving the cells switch command. In one example, the UE 405 performs TA acquisition via contention free random access (CFRA) triggered by a PDCCH order from the source cell and subsequently, the UE 405 transmits a preamble towards the indicated candidate cell in the PDCCH order. In an embodiment, to minimize the data interruption for the source cell due to CFRA towards the candidate cell(s), the UE 405 does not receive a random access response (RAR) for the purpose of TA value acquisition and the TA value of the candidate cell is indicated in the cell switch command. In one embodiment, the UE does not maintain the TA timer for the candidate cell and relies on network implementation to guarantee the TA validity. In one embodiment, the operation 455 can signal an end of the early synchronization phase 445. In such embodiments, the UE 405 and BS 410 can proceed to an LTM execution phase 460.

During the LTM execution phase 460, at operation 465, the UE 405 initially performs L1 measurements on the configured candidate cell(s) and subsequently transmits the L1 measurement reports to the BS 410.

At operation 470, the BS 410 determines to execute a cell switch to a target cell. For example, the BS 410 can receive all of the L1 measurements from the UE 405 and determine the best cell—e.g., determine a target cell for the switch.

At operation 475, the BS 410 can transmit a MAC CE which triggers a cell switch. In one embodiment, the MAC CE includes the candidate configuration index of the target cell.

At operation 480, the UE 405 detaches from the source cell and applies the target cell configurations—e.g., the UE 405 switches to the target cell and applies the configuration indicated by the candidate configuration index (e.g., or candidate configuration index plus one (+1)). Each candidate configuration can be assigned candidate configuration index starting from 1, for example, if there are four candidate configurations they can be indexed from 1 to 4. In the LTM cell switch command, candidate configuration index field may indicate values from 1 to 4 in which case candidate configuration index field directly indicates the candidate configuration index of candidate configuration. In the LTM cell switch command, candidate configuration index field may indicate values from 0 to 3 in which case the value of candidate configuration index field+1 indicates the candidate configuration index of candidate configuration. Alternately, each candidate configuration can be assigned candidate configuration index starting from 0, for example, if there are four candidate configurations they can be indexed from 0 to 3. In the LTM cell switch command, candidate configuration index field may indicate values from 0 to 3 in which case candidate configuration index field directly indicates the candidate configuration index of candidate configuration.

At operation 485, the UE 405 performs a random access procedure (RACH) towards the target cell, if the UE does not have a valid TA of the target cell. In at least one embodiment, operation 485 signals the end of the LTM execution phase 460. In such embodiments, the UE 405 and BS 410 can proceed to the LTM completion phase 490.

At operation 495, the UE 405 can perform LTM completion. For example, the UE 405 completes the LTM cell switch procedure by sending an RRC reconfiguration complete message (e.g., RRCReconfigurationComplete) to the target cell. If the UE 405 has performed an RA procedure at operation 485, the UE 405 considers the LTM execution as successfully completed when the random access procedure is successfully completed. In other embodiments, the UE 405 does not perform operation 485 and instead performs RACH-less LTM. In such embodiments, the UE 405 considers the LTM execution as successfully complete when the UE 405 determines that the network has successfully received its first UL data. That is, UE 405 determines successful reception of the first UL data by receiving a PDCCH addressing the UE 405 cell radio network temporary identifier (C-RNTI) in the target cell, which schedules a new transmission following the first UL data.

However, there may be some issues encountered following the process 400 described herein. For example, if the MAC entity receives an LTM cell switch command MAC CE, then the synchronization signal block (SSB) associated to the transmission configuration indication (TCI) state indicated by the TCI state ID field in the LTM cell switch command MAC CE is the one used for configured uplink grant selection for an initial uplink transmission towards the candidate cell for RACH-less LTM cell switch. However, the LTM cell switch command MAC CE has two TCI state fields, TCI state ID field and a UL TCI state ID field. That is, current operations do not take into account separate TCI states for DL and UL or the presence of two TCI state fields in the LTM cell switch command MAC CE. For example, the LTM cell switch command MAC CE has two TCI state fields present, a TCI state ID and a UL TCI state ID. In examples where the TCI state ID is not joint (e.g., a different TCI state ID vs UL TCI state ID), the DL TCI state ID indicated by the TCI state ID field of the MAC CE is used for configured uplink grant selection. Accordingly, the network may be unable to receive the transmission from the UE 405 as the DL TCI state is used by the UE 405 for UL transmissions.

Additionally, in some examples the TCI state indicated in the LTM cell switch command MAC CE can be associated with a CSI-RS. However, the configured uplink grants for the initial uplink transmission are associated with SSB(s). Therefore, current operations are insufficient to select the configured uplink grant for the initial uplink transmission towards the candidate cell for RACH-less LTM cell switch.

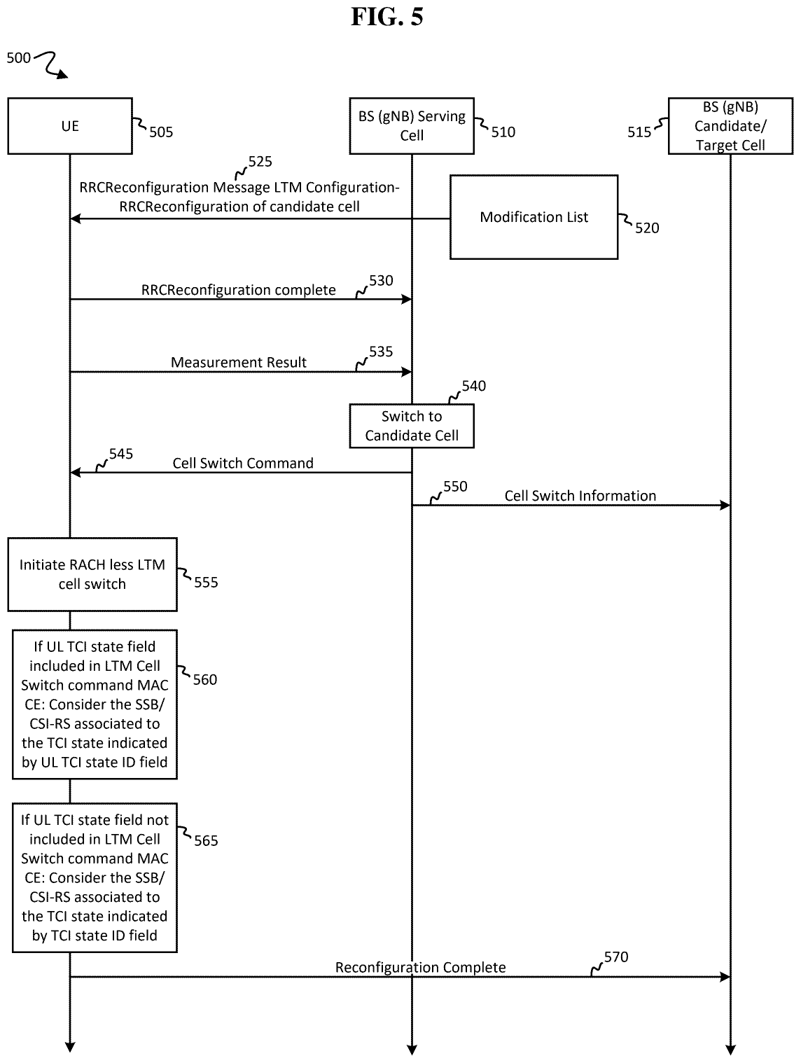

FIG. 5 shows an example process 500 for a layer 1/layer 2 (L1/L2) triggered mobility (LTM) operation. For explanatory and illustration purposes, the example process 500 may be performed by user equipment (UE) 505 (e.g., UE 111-116 as described with reference to FIG. 1) and base station (BS) 510 (e.g., BS 101-103 as described with reference to FIG. 1). In some embodiments, the BS 510 is an example of a next generation node B, gNodeB (gNB). In one embodiment, the BS 510 is an example of a BS of cell A or a serving cell. In one embodiment, the example process 500 can also include a BS of cell B or a candidate/target cell. In one embodiment, the process 500 illustrates an example LTM operation where the UE 505 switches from the serving cell to the target cell—e.g., from the BS 510 to the BS 515. In some embodiments, a processor or transceiver of the UE 505 or BS 510 can perform the operations described herein. Although one or more operations are described or shown in particular sequential order, in other embodiments the operations may be rearranged in a different order, which may include performance of multiple operations in at least partially overlapping time periods.

At operation 525, the BS 510 of serving cell A provides an LTM configuration of candidate cell B to the UE 505. In one embodiment, the LTM configuration is included in a radio resource control (RRC) message. In one embodiment, the LTM configuration of candidate cell B includes configurations of cell B to be applied in case an LTM cell switch procedure is executed to cell B. In one embodiment, the LTM configuration is signaled by including a RRCReconfiguration information element (IE) for the candidate cell in the LTM configuration. In at least one embodiment, the LTM configuration can include random access configuration. In such examples, the random access configuration can be there for one or more uplink bandwidth parts (BWPs). In one embodiment, the LTM configuration includes configured grant (CG) configurations to be applied at a time of the LTM cell switch. In such embodiments, the CG resources or the CG occasions configured are associated with SSB(s) and/or CSI-RS(s). For example, all the CG resources or CG occasions configured are associated with SSB(s), or all the CG resources or CG occasions configured are associated with CSI-RS(s), or some of the CG resources or CG occasions configured are associated with SSB(s) and others are associated with CSI-RS(s). In at least one embodiment, the LTM configuration of candidate cell B can include a synchronization signal (SS)-reference signal received power (RSRP threshold) and/or a CSI-RSRP threshold for selection of configured uplink grant. In one embodiment, the LTM configuration of the candidate cell B can include one or more lists of TCI states. For example, the TCI state can be associated with an RS (e.g., a reference signal such as SSB, CSI, or tracking reference signal (TRS)). In some embodiments, the TCI states can be included in a modification list 520. For example, the LTM configuration of candidate cell B can include a modification list 520 (e.g., ltm-DL-OrJointTCI-StateToAddModList 520). In one embodiment, the TCI state is identified by a TCI-UL-StateId in a ltm-DL-OrJointTCI-StateToAddModList. In one embodiment, the LTM configuration of candidate Cell B can include ltm-ULTCI-StatesToAddModList. In such embodiments, the UL TCI state is identified by the TCI-UL-StateId in the ltm-ULTCI-StatesToAddModList. In one embodiment, the LTM configuration of candidate cell B can include unifiedTCI-StateType, where the unifiedTCIStateType is set to either ‘separate’ or ‘joint.’ In one embodiment, separate’ can indicate the UL and DL TCI states are different while ‘joint’ can indicate the UL and DL TCI states are the same. In one embodiment, in a case where cell A and cell B belong to different distributed units (DUs) of a same gNB, the BS 510 (e.g., gNB) can obtain a configuration of cell B from the DU of cell B. In a case where cell A and cell B belong to different DU of different gNBs, the BS 510 (e.g., gNB) or centralized unit (CU) of cell A can obtain the configuration of cell B from the BS 515 of cell B (e.g., gNB or CU of cell B). In one embodiment, the LTM configuration of candidate cell B can also include a layer 1 (L1) measurement configuration.

At operation 530, the UE 505 confirms the RRCReconfiguration message received at operation 525. In such embodiments, the UE 505 transmits a RRCReconfiguration complete message to the BS 510.

At operation 535, the UE 505 transmits one or more L1 measurement reports upon performing the measurement indicated in the L1 measurement configuration—e.g., the UE 505 can proceed to perform one or more measurements after receiving the L1 measurement configuration based on the measurements included in the L1 measurement configuration.

At operation 540, the BS 510 of cell A can determine to execute a cell switch to a target cell B (e.g., to BS 515). In some embodiments, the BS 510 can determine to perform the cell switch based on the measurement result received at operation 535. For example, the UE 505 can receive an LTM configuration of multiple candidate cells where each configuration is identified by a candidate configuration index. In some embodiments, the BS 510 can provide the LTM candidate configuration based on a signal strength of the UE 505 being below a threshold—e.g., being below a SS-RSRP threshold for example. In some embodiments, the BS 510 can determine to execute a cell switch based on which candidate cell is best for the UE 505—e.g., based on the measurements for each candidate cell provided by the UE 505.

At operation 545, the BS 510 of cell A can transmit an LTM cell switch command to the UE 505. In such embodiments, the LTM cell switch command can be a MAC CE (e.g., LTM cell switch command MAC CE) or downlink control information (DCI) and can include information (e.g., a candidate configuration index) to identify a target cell B. In one embodiment, the cell switch command can include one or more of a TCI state ID, a UL TCI state ID, TA, or contention free random access resources (e.g., SSB index/CSI-RS index, preamble index, RACH occasion mask index, PUSCH occasion index). In one embodiment, the contention free random access resources (e.g., SSB index/CSI-RS index, preamble index, RACH occasion mask index, PUSCH occasion index) can be included if the TA is not included.

At operation 550, the BS 510 of cell A transmits cell switch information to BS 515 of cell B. In one embodiment, the cell switch information can include TCI state ID, UL TCI state ID, TA, contention free random access resources (e.g., SSB index/CSI-RS index, preamble index, RACH occasion mask index, PUSCH occasion index).

At operation 555 the UE can initiate the switch to the BS 515 of target cell B. That is, the UE 505 can initiate a RACH less LTM cell switch. In one embodiment, the UE 505 can perform the cell switch by applying the configuration indicated by a candidate configuration index—e.g., the UE 505 can receive an LTM configuration index of multiple candidate cells at operation 505 where each configuration is identified by the configuration index and the UE 505 applies the candidate cell configuration information based on the configuration index received in the LTM cell switch command. In one embodiment, for RACH-less LTM cell switch, the UE selects a configured uplink grant from the configuration of configured uplink grant configurations for RACH-less LTM cell switch. In one embodiment, the UE can transmit the RRCReconfigurationComplete message in the selected configured uplink grant to the target cell.

For example, at operation 560, if the UL TCI state ID field is included in the LTM cell switch command or the LTM cell switch command MAC CE (e.g., the cell switch command of operation 545), or if the unifiedTCI-StateType in LTM candidate configuration is set to ‘separate’ or if the ltm-UL-TCI-StatesToAddModList is included in the LTM candidate configuration, then the UE 505/MAC entity in the UE 505 considers the SSB associated to the TCI state indicated by the UL TCI state ID field as the one used for configurated uplink grant selection for an initial uplink transmission towards the candidate cell/target cell for RACH-less LTM cell switch. In such embodiments, the SSB associated with the TCI state signaled in the TCI state list is received at operation 525. In one embodiment, if the SS-RSRP of this SSB (e.g., the one associated with the UL TCI state ID) is above the SS-RSRP threshold, the UE 505 considers the CG corresponding to this SSB as valid and is used for UL transmission for the LTM candidate cell indicated in the LTM cell switch command MAC CE of operation 545. In some embodiments, (e.g., if the UL state field is included in the LTM command), then UE 505 proceeds to operation 570. Otherwise, the UE 505 proceeds to operation 565.

At operation 565, if the UL TCI state field is not included in the LTM cell switch command MAC CE or if the unifiedTCI-StateType in the LTM candidate configuration is set to ‘joint’ or if the ltm-UL-TCI-StatesToAddModList is not included in the LTM candidate configuration, then the UE 505/MAC entity consider the SSB associated to the TCI state indicated by the TCI state ID field as the one used for configured uplink grant selection for the initial uplink transmission towards the candidate cell/target cell for RACH-less LTM cell switch. In one embodiment, the SSB associated to the TCI state signaled by the TCI state list is received at operation 525. In one embodiment, if the SS-RSRP of this SSB (e.g., the SSB associated with TCI state ID) is above the SS-RSRP threshold, the UE 505 considers the configured grant corresponding to that SSB as valid and uses the SSB for UL transmission to the LTM candidate cell indicated in the LTM cell switch command MAC CE.

In one embodiment, the TCI state indicated in the LTM cell switch command or LTM cell switch command MAC CE (e.g., the cell switch command of operation 545) is associated with a CSI-RS. In such embodiments, if a UL TCI state field is included in the LTM cell switch command or LTM cell switch command MAC CE (e.g., or if a unifiedTCI-State Type in the LTM candidate configuration is set to ‘separate’ or if ltm-UL-TCI-StatesToAddModList is included in the LTM candidate configuration), then the UE 505/MAC entity considers the CSI-RS associated to the TCI state indicated by the UL TCI state ID field as the one used for the configured uplink grant selection for the initial uplink transmission toward the candidate cell/target cell for RACH-less LTM cell switch. In at least one embodiment, the CSI-RS associated to the TCI state is signaled in the TCI state list received at operation 525 (e.g., based on the modification list 520). In one embodiment, if the CSI-reference signal received power (RSRP) of the present CSI-RS (e.g., the one associated with the UL TCI state ID field) is above a CSI-RSRP threshold, the UE 505 then considers the configured grant corresponding to the present CSI-RS as valid and is used for UL transmission to LTM candidate cell indicated in the LTM cell switch command or LTM cell switch command MAC CE. In other embodiments, where the UL TCI state field is not included in the LTM cell switch command MAC CE or if the unifiedTCI-StateType in the LTM candidate configuration is set to ‘joint’ or if the ltm-UL-TCI-StatesToAddModList is not included in the LTM candidate configuration, then the UE 505/MAC entity considers the CSI-RS associated to the TCI state indicated by the TCI state ID field as the one used for the configured uplink grant selection for the initial uplink transmission towards the candidate cell/target cell for RACH-less LTM cell switch. In at least one embodiment, the CSI-RS associated to the TCI state indicated by the TCI state ID field as the one used for configured uplink grant selection for the initial uplink transmission towards the candidate cell/target cell for RACH-less LTM cell switch. In at least one embodiment, the CSI-RS associated to the TCI state is signaled in the TCI state list received at operation 525. In one embodiment, if the CSI-RSRP of the present CSI-RS (e.g., the one associated with the TCI state ID field) is above the CSI-RSRP threshold, the UE considers the configured grant corresponding to the present CSI-RS as valid and is used for UL transmission to LTM candidate cell/target cell indicated in the LTM cell switch command or LTM cell switch command MAC CE.

In one embodiment, the TCI state indicated in the LTM cell switch command or LTM cell switch command MAC CE is associated with a CSI-RS and configured uplink grant(s) are associated with SSB(s). In such embodiments, if the UL TCI state field is included in the LTM cell switch command or LTM cell switch command MAC CE (e.g., or if unifiedTCI-StateType in the LTM candidate configuration is set to ‘separate’ or if ltm-UL-TCI-StatesToAddModList is included in the LTM candidate configuration, then the UE 505/MAC entity considers the SSB quasi-collocated (QCLed) with the CSI-RS associated to the TCI state indicated by the UL TCI state ID field as the one used for the configured uplink grant selection for the initial uplink transmission towards the candidate cell/target cell for RACH-less LTM cell switch. In such embodiments, the CSI-RS associated to the TCI state is signaled in the TCI state list received at operation 525. In one embodiment, the SSB QCLed with the CSI-RS is also signaled in the TCI state list received at operation 525. In at least one embodiment, if the synchronization signal (SS)-RSRP of the present SSB (e.g., the QCLed with the CSI-RS associated to the UL TCI state field) is above an SS-RSRP threshold, the UE 505 considers the configured grant corresponding to the present SSB as valid and is used for UL transmission to the LTM candidate cell indicated in the LTM cell switch command or LTM cell switch command MAC CE. In other embodiments, if the UL TCI state field is not included in the LTM cell switch command or LTM cell switch command MAC CE or if the unifiedTCI-State Type in the LTM candidate configuration is set to ‘joint’ or the ltm-UL-TCI-StatesToAddModList is not included in the LTM candidate configuration, then the UE 505/MAC entity considers the SSB quasi-collocated (QCLed) with the CSI-RS associated to the TCI state indicated by the TCI state ID field as the one used for the configured uplink grant selection for the initial uplink transmission towards the candidate cell/target cell for RACH-less LTM cell switch. In such embodiments, the CSI-RS associated to the TCI state is signaled in the TCI state list received at operation 525. In one embodiment, the SSB QCLed with the CSI-RS is also signaled in the TCI state list received at operation 525. In at least one embodiment, if the synchronization signal (SS)-RSRP of the present SSB (e.g., the QCLed with the CSI-RS associated to the TCI state field) is above an SS-RSRP threshold, the UE 505 considers the configured grant corresponding to the present SSB as valid and is used for UL transmission to the LTM candidate cell indicated in the LTM cell switch command or LTM cell switch command MAC CE.

In one embodiment, the TCI state indicated in the LTM cell switch command or LTM cell switch command MAC CE is associated with a tracking reference signal (TRS) and configured uplink grant(s) are associated with TRS(s). In such embodiments, if the UL TCI state field is included in the LTM cell switch command or LTM cell switch command MAC CE (e.g., or if the unifiedTCI-StateType in the LTM candidate configuration is set to ‘separate’ or if the ltm-UL-TCI-StatesToAddModList is included in the LTM candidate configuration), then the UE 505/MAC entity in UE 505 considers the TRS associated to the TCI state indicated by the UL TCI state ID field as the one used for the configured uplink grant selection for the initial uplink transmission towards the candidate cell/target cell B for RACH-less LTM cell switch. In one embodiment, the TRS associated to the TCI state is signaled in the TCI state list received at operation 525. In at least one embodiment, if the RSRP of the current TRS (e.g., the one associated to the UL TCI state ID field) is above a threshold value, the UE 505 considers the configured grant corresponding to the present TRS as valid and is used for UL transmission to LTM candidate cells indicated in the LTM cell switch command or LTM cell switch command MAC CE. In other embodiments, if the UL TCI state ID field is not included in the LTM cell switch command or LTM cell switch command MAC CE or if the unifiedTCI-StateType in the LTM candidate configuration is set to ‘joint’ or if the ltm-UL-TCI-StateToAddModList is not included in the LTM candidate configuration, then the UE 505/MAC entity considers the TRS associated to the TCI state indicated by the TCI state ID field as the one used for the configured uplink grant selection for the initial uplink transmission towards the candidate cell/target cell for RACH-less LTM cell switch. In one embodiment, the TRS associated to the TCI state is signaled in the TCI state list received at operation 525. In at least one embodiment, if the RSRP of the current TRS (e.g., the one associated to the TCI state ID field) is above a threshold value, the UE 505 considers the configured grant corresponding to the present TRS as valid and is used for UL transmission to the LTM candidate cell indicated in the LTM cell switch command or LTM cell switch command MAC CE.

In one embodiment, the TCI state indicated in the LTM cell switch command or LTM cell switch command MAC CE is associated with a TRS and configured uplink grant(s) are associated with SSB(s). In such embodiments, if the UL TCI state field is included in the LTM cell switch command or LTM cell switch command MAC CE (e.g., or if the unifiedTCI-StateType in the LTM candidate configuration is set to ‘separate’ or if the ltm-UL-TCI-StatesToAddModList is included in the LTM candidate configuration), then the UE 505/MAC entity considers the SSB QCLed with the TRS associated to the TCI state indicated by the UL TCI state ID field as the one used for the configured uplink grant selection for the initial uplink transmission towards the candidate cell/target cell for RACH-less LTM cell switch. In one embodiment, the TRS associated to the TCI state is signaled in the TCI state list received at operation 525. In one embodiment, the SSB QCLed with the TRS is also signaled in the TCI state list received at operation 525. In at least one embodiment, if the SS-RSRP of the current SSB (e.g., the SSB QCLed with the TRS associated to the UL TCI state ID field) is above a SS-RSRP threshold, the UE 505 considers the configured grant corresponding to the present SSB as valid and is used for UL transmission to LTM candidate cell/target cell indicated in the LTM cell switch command MAC CE. In other embodiments, if the UL TCI state ID field is not included in the LTM cell switch command or LTM cell switch command MAC CE or if the unifiedTCI-StateType in the LTM candidate configuration is set to ‘joint’ or if the ltm-UL-TCI-StateToAddModList is not included in the LTM candidate configuration, then the UE/MAC entity considers the SSB QCLed with the TRS associated to the TCI state indicated by the TCI state ID field as the one used for the configured uplink grant selection for the initial uplink transmission towards the candidate cell/target cell for RACH-less LTM cell switch. In one embodiment, the TRS associated to the TCI state is signaled in the TCI state list received at operation 525. In one embodiment, the SSB QCLed with the TRS is also signaled in the TCI state list received at operation 525. In at least one embodiment, if the SS-RSRP of the current TRS (e.g., the SSB QCLed with the TRS associated to the TCI state ID field) is above the SS-RSRP threshold value, the UE 505 considers the configured grant corresponding to the present TRS as valid and is used for UL transmission to LTM candidate cell/target cell indicated in the LTM cell switch command or LTM cell switch command MAC CE.

In an embodiment, the CSI-RS based contention free random access (CFRA) resource (e.g., the random access (RA) preamble index or CSI-RS ID) can be included in the cell switch command or the LTM cell switch command MAC CE. In one embodiment, the CSI-RS based CFRA resource may also include a RA occasion index (e.g., or a list of RA occasion indexes). In at least one embodiment, the presence of the CSI-RS based CFRA resource can be indicated by one (1) bit in the LTM cell switch command MAC CE. In such embodiments, the bit can be set to one (1) to indicate a presence of the CSI-RS based CFRA resource in the LTM cell switch command MAC CE.

In one embodiment, if the CSI-RS based CFRA resource is included in the LTM cell switch command MAC CE, a “C” bit can be set to zero (0). In such embodiments, the “C” bit indicates a presence of an SSB based CFRA resource e.g., the RA preamble index, the SSB index, a PRACH mask index in the LTM cell switch command MAC CE. Accordingly, if the “C” bit is set to one (1), the bit indicating the presence of the CSI-RS based CFRA resource can be set to zero (0).

In one embodiment, if the LTM cell switch command or LTM cell switch command MAC CE includes CSI-RS based CFRA resource and the CSI RS-RSRP of the CSI-RS indicated by the CSI-RS ID in the LTM cell switch command MAC CE is above a CSI RS-RSRP threshold, the UE 505 selects the CSI-RS indicated by the CSI-RS ID, the UE 505 selects the preamble index indicated in the LTM cell switch command or LTM cell switch command MAC CE, and/or the UE 505 selects the RACH occasion corresponding to the selected CSI-RS e.g., the RACH occasion can be the one indicated by RA occasion indexes in the LTM cell switch command MAC CE, the RACH occasion can be the one indicated by a list of RA occasion indexed in RACH configuration dedicated in LTM configuration of a target cell B as received in operation 525, or the RACH occasion can be the one associated with the SSB QCLed with the CSI-RS indicated by the CSI-RS ID. In one embodiment, the UE 505 transmits a selected preamble in the selected RACH occasion to the target cell B. In one embodiment, the CSI-RS ID may not be explicitly included in the LTM cell switch command or LTM cell switch command MAC CE—e.g., or not included in the CSI-RS based CFRA resource in the LTM cell switch command MAC CE. In such embodiments, the UE 505 uses the CSI-RS in the QCL-information of the TCI state indicated by the TCI state ID field or the UL TCI state field in the LTM cell switch command MAC CE. In at least one embodiment, whether to use the CSI-RS in the QCL-information of the TCI state indicated by the TCI state ID field or the UL TCI state ID field can be indicated in the LTM cell switch command or LTM cell switch command MAC CE itself. In one embodiment, the UE 505 can utilize the CSI-RS in the QCL-information of the TCI state indicated by the TCI state ID field or the UL TCI state ID field, if the CSI-RS based CFRA resources in the LTM cell switch command MAC CE do not include the CSI-RS ID.

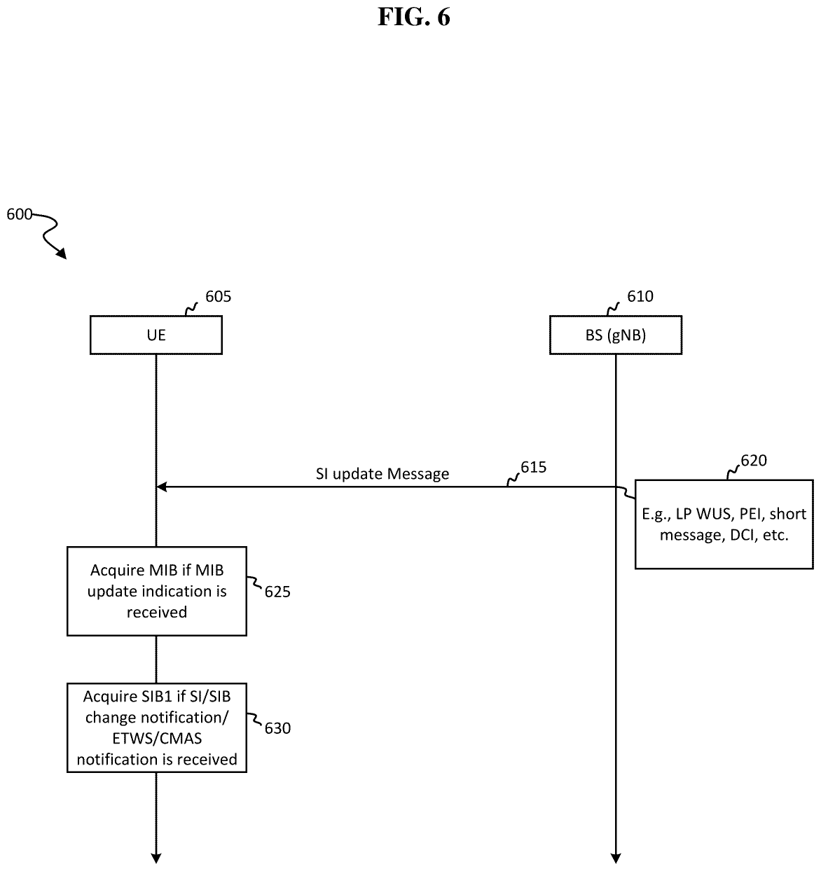

FIG. 6 shows an example process 600 for updating MIBs and SIBs in accordance with an embodiment. For explanatory and illustration purposes, the example process 600 may be performed by user equipment (UE) 605 (e.g., UE 111-116 as described with reference to FIG. 1) and base station (BS) 610 (e.g., BS 101-103 as described with reference to FIG. 1). In some embodiments, the BS 610 is an example of a next generation node B, gNodeB (gNB). In at least one embodiment, the BS 610 is a 6G node—e.g., 6G NB. In some embodiments, a processor or transceiver of the UE 605 or BS 610 can perform the operations described herein. Although one or more operations are described or shown in particular sequential order, in other embodiments the operations may be rearranged in a different order, which may include performance of multiple operations in at least partially overlapping time periods.

In at least one embodiment, system information acquisition is an important feature of a wireless communication system (e.g., a 5G, B5G, or 6G system). In an embodiment, in a next generation of wireless communication systems, for a base station 610 (e.g., node B, gNB) in cell broadcast, a synchronization signal and physical broadcast channel (PBCH) block (SSB) consists of a primary and a secondary synchronization signal (PSS and SSS, respectively) as well as system information. In some examples, the system information includes common parameters that are used to communicate in a cell. In the next generation wireless communication systems (e.g., next generation radio or NR), the system information (SI) is divided into a master information block (MIB) and a number of system information blocks (SIBs) where the MIB is always transmitted on a broadcast channel (BCH) with a periodicity of 80 milliseconds (ms) and repetitions made within 80 ms. Additionally, the MIB includes parameters that are used to acquire SIB1 from the cell. In some embodiments, the SIB1 is transmitted on a downlink shared channel (DL-SCH) with a periodicity of 160 ms and variable transmission repetition. In one example, a default transmission repetition periodicity of SIB1 is 20 ms but an actual transmission repetition periodicity is up to network implementation. For example, for SSB and control resource set (CORESET) multiplexing pattern one (1), SIB1 repetition transmission period is 20 ms. Additionally, for SSB and CORESET multiplexing pattern 2/3, SIB1 transmission repetition period is the same as the SSB period. In some examples, the SIB1 includes information regarding the availability and scheduling of other SIBs with an indication whether one or more SIBs are provided on-demand—e.g., the SIB1 can provided mapping of SIBs to SI message, periodicity, SI-window size of other SIBs, etc.). In examples where there is an indication that one or more SIBs are provided on demand, the SIB1 can include information on how the UE 605 can perform the SI request.

In one embodiment, SIB1 is a cell-specific SIB and SIBs other than SIB1 and posSIBs are carried in SI messages transmitted on the DL-SCH. However, only SIBs or posSIBs having the same periodicity can be mapped to the same SI message. In that, SIBs and posSIBs are mapped to the different SI messages. In one example, each SI message is transmitted within periodically occurring time domain windows—e.g., referred to as SI-windows with a same length for all SI messages. Further, each SI message is associated with an SI-window and the SI-windows of different SI messages do not overlap. In that, within one SI-window only the corresponding SI message is transmitted. In some examples, an SI message is transmitted a number of times within the SI-window.

In some examples, any SIB or posSIB other than SIB1 can be configured to be cell specific or area specific using an indication in SIB1. In such examples, the cell specific SIB is applicable only within a cell that provides the SIB while the area specific SIB is appliable within an area referred to as SI area. In some embodiments, the SI area consists of one or several cells and is identified by an ID (e.g., systemInformationAreaID). In one example, a mapping of SIBs to SI messages is configured in a list—e.g., in schedulingInfoList. In such examples, mapping of posSIBs to SI messages is configured in a second list—e.g., in pos-SchedulingInfoList. Each SIB is contained in a single SI message and each SIB and posSIB is contained at most once in that SI message. In some examples, when the UE 605 is in a connected mode (e.g., in RCC connected), the network can provide system information through dedicated signaling using an RRC message (e.g., RRCReconfiguration). For example, if the UE has an active bandwidth part (BWP) with no common search space configured to monitor the system information, paging, or upon request from the UE. In the connected mode (e.g., RRC_CONNECTED), the UE 605 acquires the required SIB(s) only from a primary cell (e.g., PCell). In some examples, for primary and secondary cells (e.g. PSCell) and for secondary cells (e.g., SCells), the network can provide the required SI by dedicated signaling—e.g., within a RRCReconfiguration message. Nonetheless, the UE 605 acquires a MIB of the PSCell to get a system frame number (SFN) timing of a secondary cell group (SCG) e.g., the SCG may be different from a master cell group (MCG). In some examples, upon a change of relevant SI for SCell, the network releases and adds the concerned SCell. In some examples, for a PSCell, the SI can only be changed with a reconfiguration with synchronization.

However, in conventional operations, when content of any SIB is changed or updated, the BS 610 transmits an SI change notification—e.g., transmits the SI change notification in a paging message, a short message, or in a downlink control information (DCI). In such embodiments, upon receiving the SI change notifications, the UE 605 always reacquires MIB and then reacquires SIB1. Based on a valueTag(s) received in the SIB1, the UE 605 can determine which of the remaining SIB(s) is updated. In some embodiments, after determining there are updated SIBs, the UE 605 reacquires the updated SIB(s), if needed by the UE 605 for operation in a camped cell.

The issue with the conventional operation for updating SI is that the UE 605 is forced to reacquire MIB irrespective of whether the contents of the MIB are changed or not. Being forced to reacquire the MIB can cause SI acquisition delays, increased energy consumption at the UE 605, network energy consumption, etc. Additionally, in conventional operations, the SI change notification does not indicate which SIB is updated. Accordingly, the UE 605 always is forced to acquire SIB1. However, SIB1 typically includes lots of information and when the UE 605 reacquires SIB1, all of the information is transmitted again to inform the UE 605 about the value tags—e.g., regardless of whether the additional information is changed or not, the UE 605 receives all of the information again. In such examples, the UE 605 can face further energy consumption, the network can face additional energy consumption, and there may be a delay based on the UE 605 receiving the same information again. Further, in conventional solutions, the MIB is not integrity protected. In that, the UE 605 does not know whether a received MIB is transmitted by a genuine or a fake gNB. In such embodiments, it is possible a UE 605 may camp on a cell which is not genuine and may fail to get the service—e.g., when the MIB is transmitted by a fake BS 610, the UE 605 may not receive paging or be able to access the cell. Accordingly, additional features are desired for updating SI, SIB, and MIB.

An operation of acquiring system information (SI) according to a present embodiment of this disclosure is provided with reference to FIGS. 6-11. For example, FIG. 6 illustrates an example where an MIB update indication is included in the SI update message.

Referring to operation 615, a BS 610 can transmit a MIB update indication in an SI update message 615 to the UE 605. In one embodiment, the SI update message can be a paging message, or DCI, PDCCH, MAC CE, a short message, RRC message, a low power-wake up signal (LP-WUS), or a paging early indication (PEI), etc., transmitted by the 6G BS 610. In one embodiment, the SI update message for MIB update indication can be a PDCCH addressed to a pre-defined radio network temporary identifier (RNTI) for the MIB change.

In one embodiment, the MIB update indication can be set to a value one (1) or TRUE to indicate that the MIB is changed. In such embodiments, the MIB update indication can be set to a value zero (0) or FALSE to indicate that the MIB is not changed. Alternatively, the MIB update indication is based on whether the MIB update indication is itself included in the SI update message. That is, a presence of an MIB update indication in the SI update message indicates that the MIB has changed while an absence of an MIB update indication in the SI update message indicates that the MIB has not changed.

At operation 625, the UE 605 can acquire MIB if the MIB update indication is received or if the MIB update indication is set to the value one (1)/TRUE. In that, upon receiving the SI update message, the UE 605 acquires MIB from broadcast transmissions only if the UE determines that the MIB is changed based on the MIB update indication. Alternatively, after receiving the SI update message that indicates an MIB change, the UE 605 can transmit a request for MIB to the BS 610. In such embodiments, after the request or receiving acknowledgment for the request, the UE 605 acquires MIB (e.g., from broadcast transmission of the MIB or the MIB may be provided in a dedicated manner to the UE). Accordingly, the UE 605 acquires the MIB if the MIB update indication indicates to do so but is able to skip or refrain from acquiring the MIB if the MIB update indication indicates to do so.

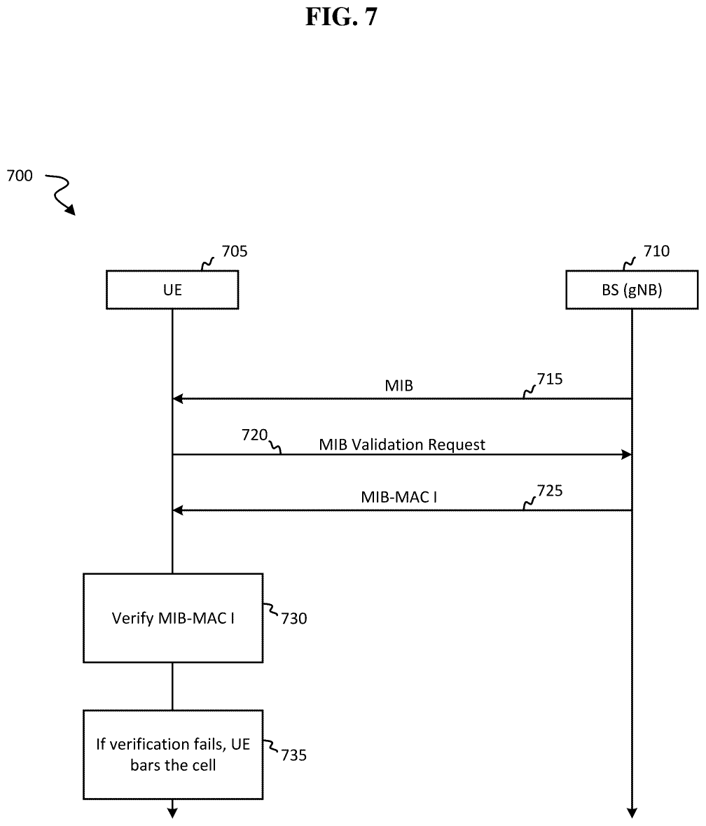

FIG. 7 shows an example process 700 for updating MIBs and SIBs in accordance with an embodiment. For explanatory and illustration purposes, the example process 700 may be performed by user equipment (UE) 705 (e.g., UE 111-116 as described with reference to FIG. 1) and base station (BS) 710 (e.g., BS 101-103 as described with reference to FIG. 1). In some embodiments, the BS 710 is an example of a next generation node B, gNodeB (gNB). In at least one embodiment, the BS 710 is a 6G node—e.g., 6G NB. In some embodiments, a processor or transceiver of the UE 705 or BS 710 can perform the operations described herein. Although one or more operations are described or shown in particular sequential order, in other embodiments the operations may be rearranged in a different order, which may include performance of multiple operations in at least partially overlapping time periods.

At operation 715, the BS 710 transmits a MIB to the UE 705. In such examples, the UE 705 receives the MIB.

At operation 720, the UE transmits a MIB validation request to the BS 710—e.g., after receiving the MIB, the UE transmits the MIB validation request. In some embodiments, the MIB validation request can be an RRC message (e.g., transmitted in a message 3 (Msg3) or message A (MsgA) during a random access procedure)—e.g., Msg3 and MsgA can be PUSCH which may carry a RRC message/MAC CE, etc. In other embodiments, the UE 705 can transmit the MIB validation request as a physical random access channel (PRACH) preamble transmission using dedicated RACH resources (e.g., preamble and/or RACH occasions (RO)) for the MIB validation requests.

At operation 725, in response to receiving the MIB validation request, the BS 710 transmits a MIB-MAC I message to the UE 705.

At operation 730, the UE 705 can verify the MIB-MAC I. For example, the UE 705 generates a MIB-MAC I (e.g., a generated MIB-MAC I) based on the contents of the received MIB and a security key. After generating the MIB-MAC I, the UE compares the generated MIB-MAC I with the MIB-MAC I received from the BS 710 at operation 725—e.g., the received MIB-MAC I. In some embodiments, the security key for the MIB-MAC I generation can be preconfigured—e.g., as part of an electronic sim (e) SIM configuration.

The UE 705 can verify the MIB-MAC I successfully if the generated MIB-MAC I is the same as the received MIB-MAC I. However, if the generated MIB-MAC I is different than the received MIB-MAC I, the UE 705 can proceed to operation 735—e.g., the verification fails if the generated MIB-MAC I is different than the received MIB-MAC I.

At operation 735, the UE bars the cell if the verification of the MIB-MAC I fails. That is, if the generated MIB-MAC I is not the same as the received MIB-MAC I from the BS 710, the UE 705 considers the received MIB in operation 715 as fake or considers the BS 710 that transmitted the MIB as fake. Accordingly, the UE 705 can bar the cell—e.g., for a pre-defined or configured time. In some embodiments, the UE 705 can store the identity of the fake BS 710 as well as the current location coordinates and report them to the network to assist the network in identifying the fake BS 710 sites if the verification fails. Accordingly, process 700 provides a mechanism for the UE 705 to ensure the received MIB is not a fake MIB or from a fake BS 710.

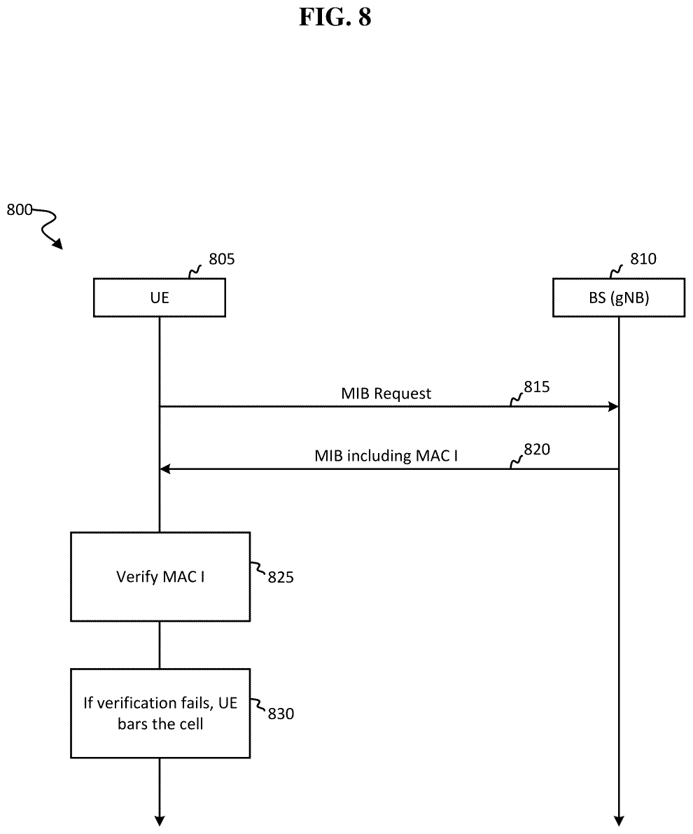

FIG. 8 shows an example process 800 for updating MIBs and SIBs in accordance with an embodiment. For explanatory and illustration purposes, the example process 800 may be performed by user equipment (UE) 805 (e.g., UE 111-116 as described with reference to FIG. 1) and base station (BS) 810 (e.g., BS 101-103 as described with reference to FIG. 1). In some embodiments, the BS 810 is an example of a next generation node B, gNodeB (gNB). In at least one embodiment, the BS 810 is a 6G node—e.g., 6G NB. In some embodiments, a processor or transceiver of the UE 805 or BS 810 can perform the operations described herein. Although one or more operations are described or shown in particular sequential order, in other embodiments the operations may be rearranged in a different order, which may include performance of multiple operations in at least partially overlapping time periods.

At operation 815, the UE 805 transmits a MIB request to the BS 810. In some embodiments, the UE 805 transmits the MIB request as an RRC message or a PRACH preamble transmission using dedicated RACH resources for the MIB request—e.g., the UE 805 transmits the MIB in a Msg3 or MsgA during a random access procedure using the RRC signaling or utilizing a preamble and/or RACH opportunity (RO) resources of a RACH.

At operation 820, the BS 810 transmits a MIB including a MIB-MAC I upon receiving the MIB request.

At operation 825, the UE verifies the MAC I. That is, the UE 805 generates a MIB-MAC I (e.g., a generated MIB-MAC I) based on the contents of the received MIB and a security key. After generating the MIB-MAC I, the UE 805 compares the generated MIB-MAC I with the MIB-MAC I received from the BS 810 at operation 820—e.g., the received MIB-MAC I. In some embodiments, the security key for the MIB-MAC I generation can be preconfigured—e.g., as part of an electronic sim (e) SIM configuration.

The UE 805 can verify the MIB-MAC I successfully if the generated MIB-MAC I is the same as the received MIB-MAC I. However, if the generated MIB-MAC I is different than the received MIB-MAC I, the UE 805 can proceed to operation 830—e.g., the verification fails if the generated MIB-MAC I is different than the received MIB-MAC I.

At operation 830, the UE bars the cell if the verification of the MIB-MAC I fails. That is, if the generated MIB-MAC I is not the same as the received MIB-MAC I from the BS 810, the UE 805 considers the received MIB in operation 815 as fake or considers the BS 810 that transmitted the MIB as fake. Accordingly, the UE 805 can bar the cell—e.g., for a pre-defined or configured time. In some embodiments, the UE 805 can store the identity of the fake BS 810 as well as the current location coordinates and report them to the network to assist the network in identifying the fake BS 810 sites if the verification fails. Accordingly, process 800 provides a mechanism for the UE 705 to ensure the received MIB is not a fake MIB or from a fake BS 810.

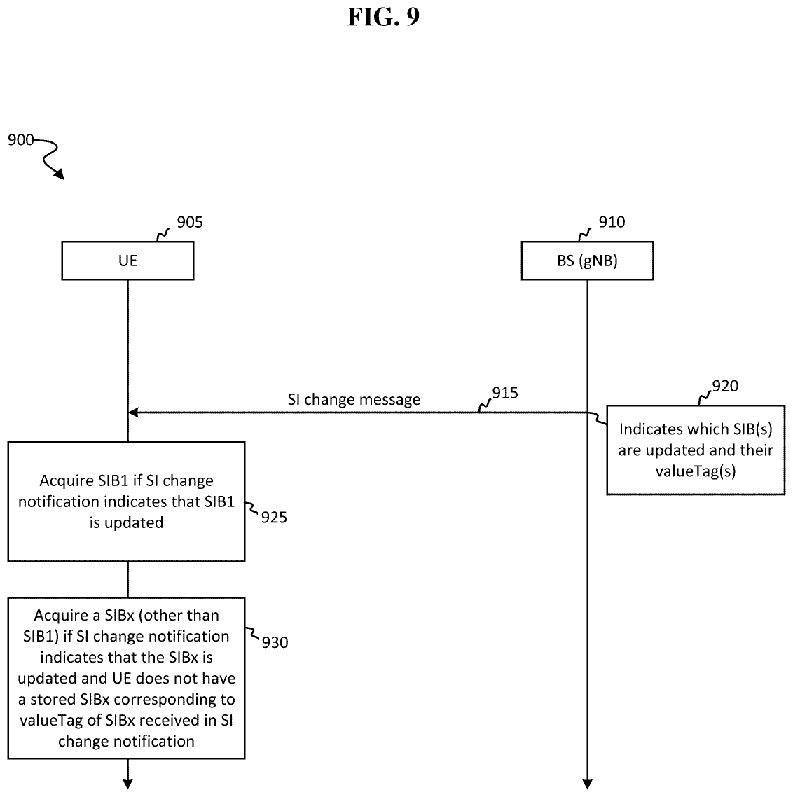

FIG. 9 shows an example process 900 for updating MIBs and SIBs in accordance with an embodiment. For explanatory and illustration purposes, the example process 900 may be performed by user equipment (UE) 905 (e.g., UE 111-116 as described with reference to FIG. 1) and base station (BS) 910 (e.g., BS 101-103 as described with reference to FIG. 1). In some embodiments, the BS 910 is an example of a next generation node B, gNodeB (gNB). In at least one embodiment, the BS 910 is a 6G node—e.g., 6G NB. In some embodiments, a processor or transceiver of the UE 905 or BS 910 can perform the operations described herein. Although one or more operations are described or shown in particular sequential order, in other embodiments the operations may be rearranged in a different order, which may include performance of multiple operations in at least partially overlapping time periods.

Referring to operation 915, a BS 910 can transmit an SI update message/change notification 915 to the UE 905. In one embodiment, the SI update message/change notification can be included in a broader message 920. For example, the SI update message can be included in a paging message, in DCI, PDCCH, MAC CE, a short message, RRC message, a low power-wake up signal (LP-WUS), or a paging early indication (PEI), etc., transmitted by the 6G BS 910. In one embodiment, the SI update message/change notification can indicate which SIB(s) are updated and their valueTag(s). In some embodiments, the SI update message or notification can also include scheduling information of the SIB(s).

At operation 925, the UE 905 acquires (e.g., reacquires) SIB1 upon receiving the SI update message/SI change notification, if the SI update message/SI change notification indicates that SIB1 is updated. In that, the UE 905 does not acquire SIB1 upon receiving the SI update message/SI change notification, if the SI update message/SI change notification indicates that SIB1 is not updated or does not indicate that SIB1 is updated.

At operation 930, the UE 905 acquires a SIBx (e.g., where SIBx can be any SIB other than SIB1, and where ‘x’ is a whole number greater than 1) if the SI update message/SI change notification indicates that the respective SIBx is updated and the UE 905 does not have a stored SIBx corresponding to a valueTag of the SIBx received in the SI update message/SI change notification. In other embodiments, the UE 905 can refrain from acquiring SIBx where the SI update message/SI change notification indicates that the respective SIBx is not updated or does not indicate that the respective SIBx is updated. In at least one embodiment, SIB1 as described herein does not include valueTag(s) of the remaining SIBs transmitted in the cell. Rather, the valueTag(s) of each SIB (e.g., of each SIBx) can be included in the SIB itself. Accordingly, the UE 905 can update a SIBx without necessarily having to reacquire SIB1.

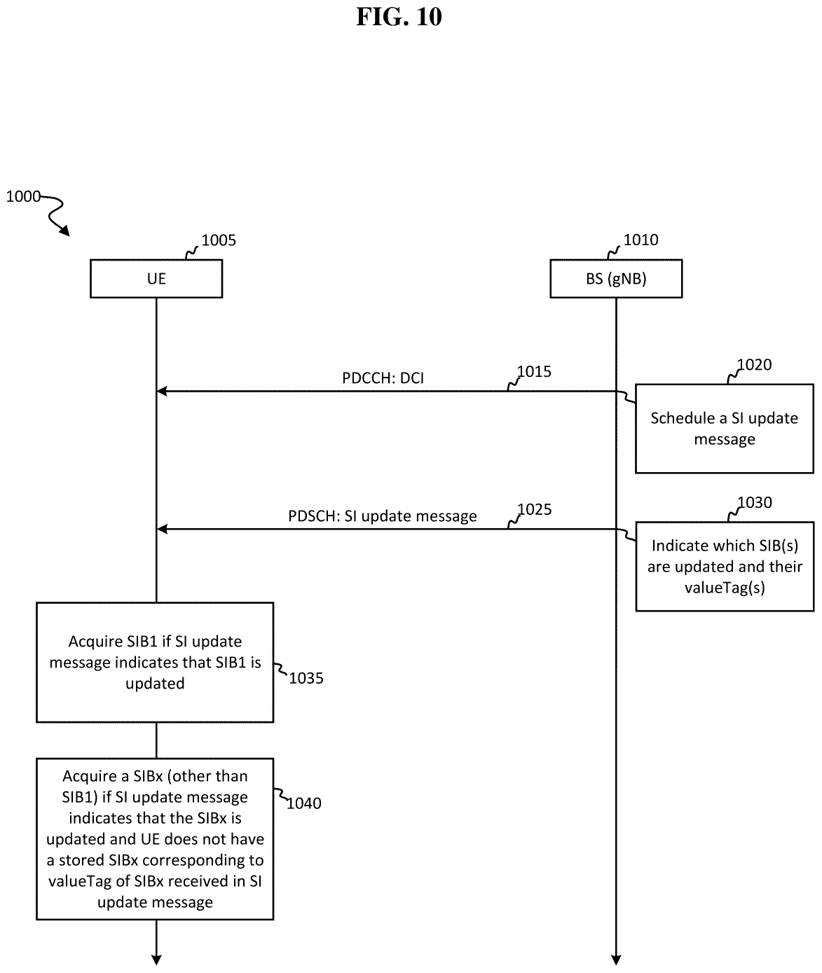

FIG. 10 shows an example process 1000 for updating MIBs and SIBs in accordance with an embodiment. For explanatory and illustration purposes, the example process 1000 may be performed by user equipment (UE) 1005 (e.g., UE 111-116 as described with reference to FIG. 1) and base station (BS) 1010 (e.g., BS 101-103 as described with reference to FIG. 1). In some embodiments, the BS 1010 is an example of a next generation node B, gNodeB (gNB). In at least one embodiment, the BS 1010 is a 6G node—e.g., 6G NB. In some embodiments, a processor or transceiver of the UE 1005 or BS 1010 can perform the operations described herein. Although one or more operations are described or shown in particular sequential order, in other embodiments the operations may be rearranged in a different order, which may include performance of multiple operations in at least partially overlapping time periods.

At operation 1015, the BS 1010 transmits a physical downlink control channel (PDCCH) (e.g., DCI) scheduling an SI update message 1020 (e.g., or an SI message, RRC message, MAC CE message, or a special SIB). In one embodiment, the PDCCH can be addressed to a pre-defined RNTI. In operation 1015, the UE 1005 can receive the PDCCH (DCI) from the BS 1010 scheduling an SI update message.

At operation 1025, the BS 1010 transmits to the UE 1005 a physical downlink shared channel (PDSCH) based on scheduling information transmitted in the PDCCH (DCI). In an embodiment, the PDSCH includes an SI update message (e.g., SI message, RRC message, MAC CE, or special SIB). In one embodiment, the SI update message can include the content 1030. That is, the SI update message can indicates which SIB(s) are updated and their corresponding valueTag(s). In one embodiment, the SI update message can also include scheduling information of the SIB(s).

At operation 1035, following the reception of the SI update message, the UE 1005 can acquire (e.g., reacquire) SIB1 if the SI message indicates that SIB1 is updated. In other embodiments, the UE 1005 can refrain from acquiring SIB1 if the SI message indicates that the SIB1 is not updated or does not indicate that SIB1 is updated.

At operation 1040, the UE 1005 acquires (e.g., or reacquires) a SIBx (e.g., where SIBx is any SIB other than SIB1, and where ‘x’ is a whole number greater than one (1)) if the SI update message indicates that SIBx is updated and the UE 1005 does not have a stored SIBx corresponding to the respective valueTag of SIBx received in the SI update message. In other embodiments, the UE 1005 can refrain from acquiring SIBx where the SI change notification indicates that the respective SIBx is not updated or does not indicate that SIBx is updated. In at least one embodiment, SIB1 as described herein does not include valueTag(s) of the remaining SIBs transmitted in the cell. Rather, the valueTag(s) of each SIB (e.g., of each SIBx) can be included in the SIB itself. Accordingly, the UE 905 does not need to acquire SIB1 to receive updated valueTags of updated SIB(s) and the valueTags of the updated SIBx can be received directly in the SI update message.

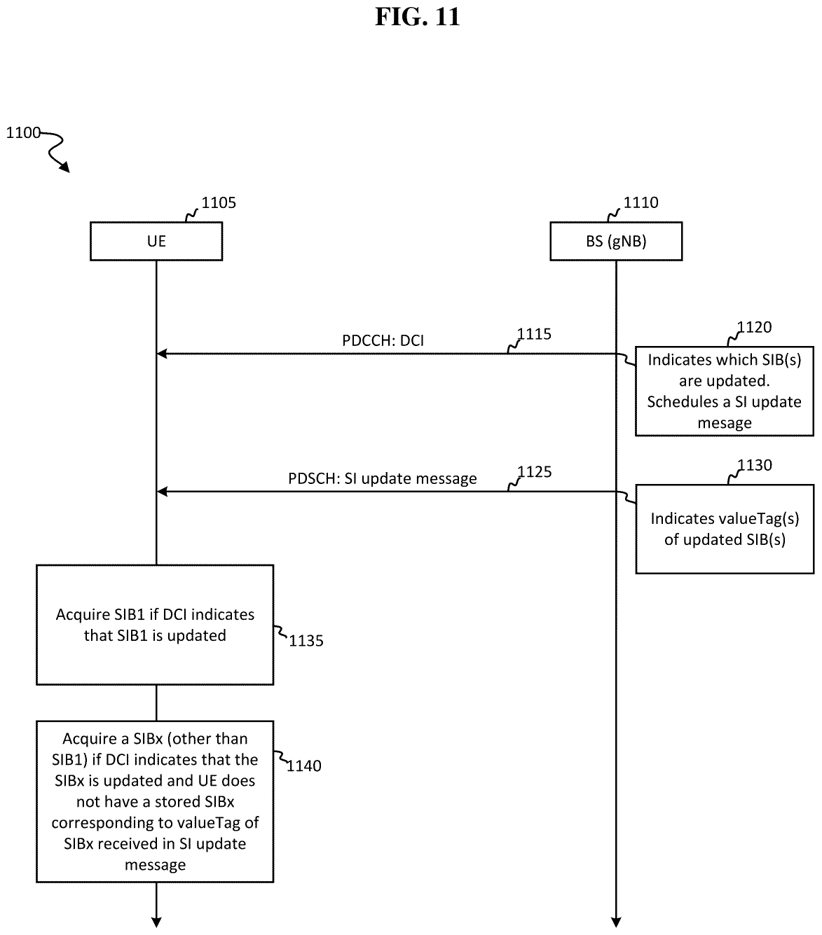

FIG. 11 shows an example process 1100 for updating MIBs and SIBs in accordance with an embodiment. For explanatory and illustration purposes, the example process 1100 may be performed by user equipment (UE) 1105 (e.g., UE 111-116 as described with reference to FIG. 1) and base station (BS) 1110 (e.g., BS 101-103 as described with reference to FIG. 1). In some embodiments, the BS 1110 is an example of a next generation node B, gNodeB (gNB). In at least one embodiment, the BS 1110 is a 6G node—e.g., 6G NB. In some embodiments, a processor or transceiver of the UE 1105 or BS 1110 can perform the operations described herein. Although one or more operations are described or shown in particular sequential order, in other embodiments the operations may be rearranged in a different order, which may include performance of multiple operations in at least partially overlapping time periods.

At operation 1115, the BS 1110 transmits a physical downlink control channel (PDCCH) (e.g., DCI) scheduling an SI update message 1120 (e.g., or an SI message, RRC message, MAC CE message, or a special SIB). In one embodiment, the PDCCH can be addressed to a pre-defined RNTI. In operation 1115, the UE 1105 can receive the PDCCH (DCI) from the BS 1110 In at least one embodiment, the PDCCH (DCI) indicates which SIB(s), if any, are updated.

At operation 1125, the BS 1110 transmits to the UE 1105 a physical downlink shared channel (PDSCH) based on scheduling information transmitted in the PDCCH (DCI). In an embodiment, the PDSCH includes an SI update message (e.g., SI message, RRC message, MAC CE, or a special SIB). In one embodiment, the SI update message can include the content 1120. That is, the SI update message can indicate which SIB(s) are updated and their corresponding valueTag(s). In one embodiment, the SI update message can also include scheduling information of the SIB(s).

At operation 1135, following the reception of the SI update message, the UE 1105 can acquire (e.g., reacquire) SIB1 if the SI message (e.g., or the PDCCH) indicates that SIB1 is updated. In other embodiments, the UE 1105 can refrain from acquiring SIB1 if the SI message indicates that the SIB1 is not updated or does not indicate that SIB1 is updated.

At operation 1140, after reception of the SI update message, the UE 1105 acquires (e.g., or reacquires) a SIBx (e.g., where SIBx is any SIB other than SIB1, and where ‘x’ is a whole number greater than one (1)) if the SI update message indicates that SIBx is updated and the UE 1105 does not have a stored SIBx corresponding to the respective valueTag of SIBx received in the SI update message. In other embodiments, the UE 1105 can refrain from acquiring SIBx where the SI change notification indicates that the respective SIBx is not updated or does not indicate that SIBx is updated. In at least one embodiment, SIB1 as described herein does not include valueTag(s) of the remaining SIBs transmitted in the cell. Rather, the valueTag(s) of each SIB (e.g., of each SIBx) can be included in the SIB itself. Accordingly, the UE 1105 does not need to acquire SIB1 to receive updated valueTags of updated SIB(s) and the valueTags of the updated SIBx can be received directly in the SI update message.

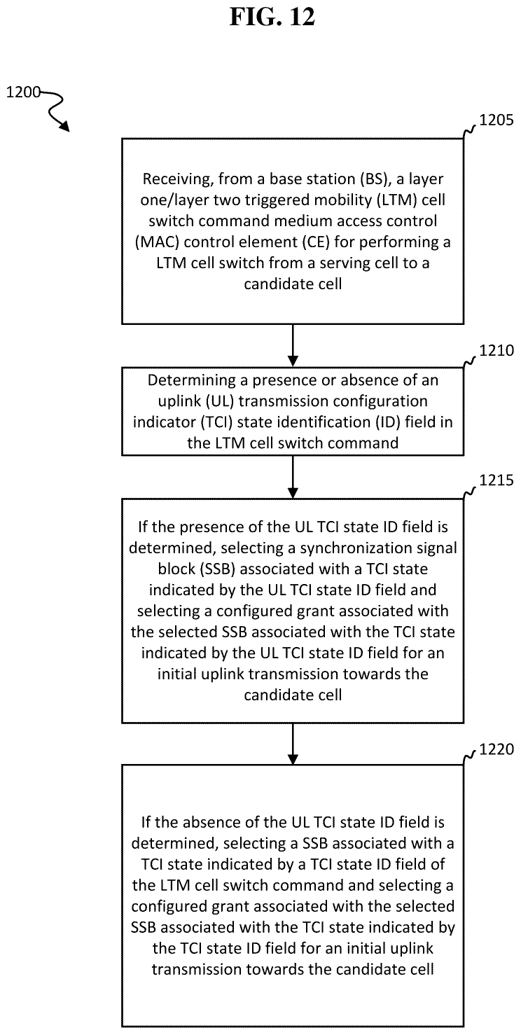

FIG. 12 shows an example LTM process 1200 in accordance with an embodiment. For explanatory and illustration purposes, the example process 1200 may be performed by user equipment (UE) (e.g., UE 111-116 as described with reference to FIG. 1, or the UE 505 described with reference to FIG. 5) and a base station (BS) (e.g., BS 101-103 as described with reference to FIG. 1, or the BS for a serving cell 510 and BS for a candidate/target cell 515 described with reference to FIG. 5). In some embodiments, the BS is an example of a next generation node B, gNodeB (gNB). In at least one embodiment, the BS is a 6G node—e.g., 6G NB. In some embodiments, a processor or transceiver of the UE or BS can perform the operations described herein. Although one or more operations are described or shown in particular sequential order, in other embodiments the operations may be rearranged in a different order, which may include performance of multiple operations in at least partially overlapping time periods.

Referring to FIG. 12, the process 1200 may begin at operation 1205. At operation 1205, the UE (e.g., a transceiver of the UE causes) receives, from a base station (BS), a layer one/layer two triggered mobility (LTM) cell switch command medium access control (MAC) control element (CE) for performing a random access channel (RACH)-less LTM cell switch procedure from a serving cell to a candidate cell.

At operation 1210, the UE (e.g., a processor of the UE causes) determines a presence or absence of an uplink (UL) transmission configuration indicator (TCI) state identification (ID) field in the LTM cell switch command. In one embodiment, the UE can determine the presence of the UL TCI state ID field and proceed to operation 1215. In other embodiments, the UE can determine the absence of the UL TCI state ID field and proceed to operation 1220—e.g., the UE performs either operation 1215 or operation 1220 based on the determination.

At operation 1215, if the presence of the UL TCI state ID field is determined, the UE selects a signal synchronization block (SSB) associated with a TCI state indicated by the UL TCI state ID field, and the UE selects a configured UL grant associated with the selected SSB associated with the TCI state indicated by the UL TCI state ID field for an initial uplink transmission towards the candidate cell.

At operation 1220, if the absence of the UL TCI state ID field is determined, the UE selects a SSB associated with a TCI state indicated by a TCI state ID field of the LTM cell switch command MAC CE and the UE selects a configured UL grant associated with the selected SSB associated with the TCI state indicated by the TCI state ID field for the initial uplink transmission towards the candidate cell.

In one embodiment, the UE receives, before the LTM cell switch command from the BS, a reconfiguration message including LTM configuration information for a plurality of candidate cells, wherein the plurality of candidate cells comprises the candidate cell. For example, the UE can receive a reconfiguration message as described with respect to operation 525 of FIG.

In one embodiment, determining the SSB associated with a TCI state indicated by the UL TCI state ID field is based at least in part on a uplink TCI state list (ltm-UL-TCI-StatesToAddModList) mapping one or more UL TCI states to one or more SSBs, wherein the list is received in the LTM configuration information—as described with reference to FIG. 5. In one embodiment, determining the SSB associated with a TCI state indicated by the TCI state ID field is based at least in part on a joint or downlink TCI state list (ltm-DL-OrJointTCI-StateToAddModList) mapping one or more joint/DL TCI states to one or more SSBs wherein the list is received in the LTM configuration information—as described with reference to FIG. 5

In some embodiments, the UE can further perform one or more measurements on the plurality of candidate cells and transmit the one or more measurements on the plurality of candidate cells to the BS, where receiving the LTM cell switch command MAC CE is based at least in part on transmitting the one or more measurements.

In one embodiment, the UE refrains from using the configured UL grant for RACH-less LTM cell switch, after completion of the LTM cell switch. After completion of the LTM cell switch, the UE stops using the grant configured for RACH-less LTM cell switch. In at least one embodiment, for the RACH-less LTM, the UE considers the LTM cell switch as successfully completed or executed when the UE determines that the network has successfully received its first UL data from the UE.

In one embodiment, the configured grant is selected from a plurality of configured grants configured by configured grant configuration for RACH-less LTM cell switch in the LTM configuration of candidate cell.

In one embodiment, where the TCI state is associated with a channel state information-reference signal (CSI-RS), the UE is to, if the UL TCI state ID field is included in the LTM cell switch command MAC CE, select a first CSI-RS associated to the TCI state indicated by the UL TCI state ID for the configured grant UL selection for the initial transmission towards the candidate cell. In other embodiment, if the UL TCI state ID field is absent in the LTM cell switch command MAC CE, the UE selects a second CSI-RS associated to the TCI state indicated by the TCI state ID field in the LTM cell switch command MAC CE for the configured grant UL selection for the initial transmission towards the candidate cell.

In one embodiment, where the TCI state is associated with a tracking reference signal (TRS), the UE is to, if the UL TCI state ID field is included in the LTM cell switch command MAC CE, select a first TRS associated to the TCI state indicated by the UL TCI state ID for the configured grant UL selection for the initial transmission towards the candidate cell. In other embodiments, if the UL TCI state ID field is absent in the LTM cell switch command MAC CE, selecting a second TRS associated to the TCI state indicated by the TCI state ID field in the LTM cell switch command MAC CE for the configured grant UL selection for the initial transmission towards the candidate cell.

Various embodiments in the disclosure provides a mechanism for a UE to select an SSB for configured uplink grant selection in a RACH-less LTM cell switch procedure based on whether a UL TCI state ID field is present in the LTM cell switch command MAC CE—e.g., the UE considers the SSB associated to the TCI state indicated by the UL TCI state ID field if present for the configured uplink grant selection or the UE considers the SSB associated to the TCI state indicated by the TCI state ID field for the configured uplink grant selection if the UL TCI state ID field is not present.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a transceiver configured to cause;
receiving, from a base station (BS), a layer one/layer two triggered mobility (LTM) cell switch command medium access control (MAC) control element (CE) for performing LTM cell switch from a serving cell to a candidate cell; and
a processor operably coupled to the transceiver, the processor configured to cause:
determining a presence or absence of an uplink (UL) transmission configuration indicator (TCI) state identification (ID) field in the LTM cell switch command MAC CE, wherein
if the presence of the UL TCI state ID field is determined, selecting a synchronization signal block (SSB) associated with a TCI state indicated by the UL TCI state ID field and selecting a configured grant associated with the selected SSB associated with the TCI state indicated by the UL TCI state ID field for an initial uplink transmission towards the candidate cell; and
if the absence of the UL TCI state ID field is determined, selecting a SSB associated with a TCI state indicated by a TCI state ID field of the LTM cell switch command MAC CE and selecting a configured grant associated with the selected SSB associated with the TCI state indicated by the TCI state ID field for the initial uplink transmission towards the candidate cell.

2. The UE of claim 1, wherein the transceiver is further configured to cause:
receiving, before the LTM cell switch command MAC CE, a reconfiguration message including LTM configuration information for a plurality of candidate cells, wherein the plurality of candidate cells comprises the candidate cell.

3. The UE of claim 2, wherein the processor is further configured to cause:
determining the SSB associated with the TCI state indicated by the UL TCI state ID field is based at least in part on an uplink TCI state list mapping one or more UL TCI states to one or more SSBs wherein the uplink TCI state list is received in the LTM configuration information; and
determining the SSB associated with the TCI state indicated by the TCI state ID field is based at least in part on a joint or downlink TCI state list mapping one or more joint or downlink TCI states to one or more SSBs wherein the joint or downlink TCI state list is received in the LTM configuration information.

4. The UE of claim 1, wherein the configured grant associated with the selected SSB is selected from a plurality of configured grants configured by configured grant configuration for random access channel (RACH)-less LTM cell switch in the LTM configuration of candidate cells.

5. The UE of claim 2, wherein the processor is further configured to cause:
performing one or more measurements on the plurality of candidate cells; and
transmitting the one or more measurements on the plurality of candidate cells to the BS, wherein receiving the LTM cell switch command MAC CE is based at least in part on transmitting the one or more measurements.

6. The UE of claim 1, wherein the TCI state is associated with a channel state information-reference signal (CSI-RS), and wherein the processor is further configured to cause:
if the UL TCI state ID field is included in the LTM cell switch command CE, selecting a first CSI-RS associated to the TCI state indicated by the UL TCI state ID for the configured grant UL selection for the initial transmission towards the candidate cell; and
if the UL TCI state ID field is absent in the LTM cell switch command MAC CE, selecting a second CSI-RS associated to the TCI state indicated by the TCI state ID field in the LTM cell switch command MAC CE for the configured grant UL selection for the initial transmission towards the candidate cell.

7. The UE of claim 1, wherein the TCI state is associated with a tracking reference signal (TRS), and wherein the processor is further configured to cause:
if the UL TCI state ID field is included in the LTM cell switch command MAC CE, selecting a first TRS associated to the TCI state indicated by the UL TCI state ID for the configured grant UL selection for the initial transmission towards the candidate cell; and
if the UL TCI state ID field is absent in the LTM cell switch command MAC CE, selecting a second TRS associated to the TCI state indicated by the TCI state ID filed in the LTM cell switch command MAC CE for the configured grant UL selection for the initial transmission towards the candidate cell.

8. A method performed by a user equipment (UE) for facilitating communication in a wireless network, comprising:
receiving, from a base station (BS), a layer one/layer two triggered mobility (LTM) cell switch command medium access control (MAC) control element (CE) for performing LTM cell switch from a serving cell to a candidate cell;
determining a presence or absence of an uplink (UL) transmission configuration indicator (TCI) state identification (ID) field in the LTM cell switch command MAC CE, wherein
if the presence of the UL TCI state ID field is determined, selecting a synchronization signal block (SSB) associated with a TCI state indicated by the UL TCI state ID field and selecting a configured grant associated with the selected SSB associated with the TCI state indicated by the UL TCI state ID field for an initial uplink transmission towards the candidate cell; and
if the absence of the UL TCI state ID field is determined, selecting a SSB associated with a TCI state indicated by a TCI state ID field of the LTM cell switch command MAC CE and selecting a configured grant associated with the selected SSB associated with the TCI state indicated by the TCI state ID field for the initial uplink transmission towards the candidate cell.

9. The method of claim 8, further comprising:
receiving, before the LTM cell switch command MAC CE, a reconfiguration message including LTM configuration information for a plurality of candidate cells, wherein the plurality of candidate cells comprises the candidate cell.

10. The method of claim 9, further comprising:
determining the SSB associated with the TCI state indicated by the UL TCI state ID field is based at least in part on an uplink TCI state list mapping one or more UL TCI states to one or more SSBs wherein the uplink TCI state list is received in the LTM configuration information; and
determining the SSB associated with the TCI state indicated by the TCI state ID field is based at least in part on a joint or downlink TCI state list mapping one or more joint or downlink TCI states to one or more SSBs wherein the joint or downlink TCI state list is received in the LTM configuration information.

11. The method of claim 9, further comprising:
performing one or more measurements on the plurality of candidate cells; and
transmitting the one or more measurements on the plurality of candidate cells to the BS, wherein receiving the LTM cell switch command MAC CE is based at least in part on transmitting the one or more measurements.

12. The UE of claim 8, wherein the configured grant associated with the selected SSB is selected from a plurality of configured grants configured by configured grant configuration for random access channel (RACH)-less LTM cell switch in the LTM configuration of candidate cells.

13. The method of claim 8, wherein the TCI state is associated with a channel state information-reference signal (CSI-RS), and wherein the method further comprises:
if the UL TCI state ID field is included in the LTM cell switch command CE, selecting a first CSI-RS associated to the TCI state indicated by the UL TCI state ID for the configured grant UL selection for the initial transmission towards the candidate cell; and
if the UL TCI state ID field is absent in the LTM cell switch command MAC CE, selecting a second CSI-RS associated to the TCI state indicated by the TCI state ID field in the LTM cell switch command MAC CE for the configured grant UL selection for the initial transmission towards the candidate cell.

14. The method of claim 8, wherein the TCI state is associated with a tracking reference signal (TRS), and wherein the method further comprises:
if the UL TCI state ID field is included in the LTM cell switch command MAC CE, selecting a first TRS associated to the TCI state indicated by the UL TCI state ID for the configured grant UL selection for the initial transmission towards the candidate cell; and
if the UL TCI state ID field is absent in the LTM cell switch command MAC CE, selecting a second TRS associated to the TCI state indicated by the TCI state ID filed in the LTM cell switch command MAC CE for the configured grant UL selection for the initial transmission towards the candidate cell.

15. A wireless network comprising two or more base stations (BS) for facilitating communication in a wireless network, the two or more BS comprising a first BS and a second BS, wherein the first BS is configured to cause:
transmitting, to a user equipment (UE), a layer one/layer two triggered mobility (LTM) cell switch command medium access control (MAC) control element (CE) for performing LTM cell switch from a serving cell associated with the first BS to a candidate cell associated with the second BS; wherein,
the second BS is configured to cause;
if an uplink (UL) transmission configuration indicator (TCI) state identification (ID) field is included in the LTM cell switch command, receiving, from the UE, an initial uplink transmission associated with a first configured UL grant corresponding to a first signal synchronization block (SSB) associated with a TCI state indicated by the UL TCI state ID field; and
if an uplink (UL) transmission configuration indicator (TCI) state identification (ID) field is absent in the LTM cell switch command, receiving, from the UE, an initial uplink transmission associated with a second configured UL grant corresponding to a second SSB associated with a TCI state indicated by a TCI state ID field of the LTM cell switch command MAC CE.

16. The wireless network of claim 14, wherein the first BS is further configured to cause:
transmitting, before the LTM cell switch command MAC CE, a reconfiguration message including LTM configuration information for a plurality of candidate cells, wherein the plurality of candidate cells comprises the candidate cell associated with the second BS.

17. The wireless network of claim 15, wherein the first BS is further configured to cause:
transmitting, to the UE in the LTM configuration information, an uplink TCI state list mapping one or more UL TCI states to one or more SSBs; and
transmitting, to the UE in the LTM configuration information, a joint or downlink TCI state list mapping one or more joint or downlink TCI states to one or more SSBs.

18. The wireless network of claim 15, wherein the first BS if further configured to cause:
receiving, from the UE, one or more measurements on the plurality of candidate cells; and
selecting, from the plurality of candidate cells, the candidate cell based at least in part on receiving the one or more measurements.

19. The wireless network of claim 15, wherein the first configured grant or second configured grant is configured by configured grant configuration for random access channel (RACH)-less LTM cell switch in the LTM configuration of the candidate cell.

20. The wireless network of claim 14, wherein the second BS is further configured to cause:
terminating the LTM cell switch procedure based at least in part on receiving the initial uplink transmission from the UE.
